(19) United States
(12) Patent Application Publication
(10) Pub. No.: US 2014/0057243 A1
(43) Pub. Date: Feb. 27, 2014

(54) EDUCATIONAL SYSTEM, TEACHER INFORMATION TERMINAL, STUDENT INFORMATION TERMINAL, INTEGRATED CIRCUIT, AND CONTENT DISPLAY METHOD

(71) Applicant: Panasonic Corporation, Osaka (JP)

(72) Inventors: Katsuhisa Yamaguchi, Osaka (JP); Hiromi Iida, Osaka (JP)

(73) Assignee: Panasonic Corporation, Osaka (JP)

(21) Appl. No.: 13/991,503

(22) PCT Filed: Sep. 26, 2012
(86) PCT No.: PCT/JP2012/006147

§ 371 Date: Jun. 4, 2013

(30) Foreign Application Priority Data
Oct. 7, 2011 (JP) 2011-223362

(51) Int. Cl. G09B 5/00

(52) U.S. Cl. CPC G09B 5/00
USPC 434/362

(57) ABSTRACT

A teacher information terminal includes a communication unit which transmits paging-forward instructions for instructing turning-forward of a page of the content, concurrently to student information terminals each time a page of the content is turned forward, and each of the student information terminals includes: a communication unit which receives a paging-forward instruction from the teacher information terminal; an inquiry unit which makes an inquiry to a user about whether or not the user accepts the paging-forward instruction when the communication unit receives the paging-forward instruction; and a paging-forward processing unit which turns forward the page of the content when a result of the inquiry is that the user accepts the paging-forward instruction, and avoids turning forward the page of the content when the result of the inquiry is that the user does not accept the paging-forward instruction.

### TECHNICAL FIELD

The present invention elates to an educational system and a content display method for giving lessons based on content whose data is the same between student information terminals and a teacher information terminal which wirelessly communicates with each of the student information terminals. Furthermore, the present invention relates to the teacher information terminal, the student information terminals, and an integrated circuit which are used in such an educational system.

### BACKGROUND ART

Educational systems for use in, for example, lessons in school or the like have been conventionally known (see Patent Literatures (PTLs) 1 and 2). These educational systems use student information terminals and a teacher information terminal which wirelessly communicates with each of the student information terminals. The student information terminals and the teacher information terminal are each tablet terminals and smart phones, for examples. Each of the student information terminals is operated by a student who receives lessons. The teacher information terminal is operated by a teacher who gives the lessons.

Display units of the respective student information terminals and a display unit of the teacher information terminal display the same page of the same content (e.g., electronic text) in synchronization. When a teacher intends to turn a page of the content forward, the teacher operates the teacher information terminal. By doing so, the page of the content displayed on the display unit of the teacher information terminal is turned forward, and pages of the content displayed on the display units of the respective student information terminals are turned forward concurrently. This way, a teacher can give lesson while sharing data of the content with students.

### CITATION LIST

### Patent Literature

[PTL 1] Japanese Unexamined Patent Application Public ion No. 2009-163306
[PTL 2] Japanese Unexamined Patent Application Publication No. 2001-273219
[PTL 3] Japanese Unexamined Patent Application Publication No. H11-282826

### SUMMARY OF INVENTION

### Technical Problem

However, the above-described conventional educational systems cause the following problem. As described above, when a teacher operates the teacher information terminal, the page of the content displayed on the display unit of each of the student information terminals is turned forward forcibly. Consequently, when there is a student who has not fully understood what has been taught in the lesson, such forcible paging forward of the content might lead the student further away from understanding the lesson.

Thus, the present invention provides an educational system, a teacher information terminal, student information terminals an integrated circuit, and a content display method which enable effective teaching.

### Solution To Problem

An educational system according to an aspect of the present invention is an educational system for giving a lesson based on content whose data is same between student information terminals and a teacher information terminal which wirelessly communicates with each of the student information terminals, the teacher information terminal including: a first display control unit configured to cause the content to be displayed on a first display unit; and a transmitting unit configured to transmit paging-forward instructions concurrently to the student information terminals each time a page of the content displayed on the first display unit is turned forward, the paging-forward instructions each being for instructing turning-forward of the page of the content, and the student information terminals each including: a second display control unit configured to cause same data as data of the page of the content displayed on the first display unit to be displayed on a second display unit; a receiving unit configured to receive one of the paging-forward instructions from the teacher information terminal; an inquiry unit configured to make an inquiry to a user of the student information terminal about whether or not the user accepts the paging-forward instruction when the receiving unit receives the paging-forward instruction; and a paging-forward processing unit configured to turn forward a page of the content displayed on the second display unit of the student information terminal when a result of the inquiry is that the user accepts the paging-forward instruction, and avoid turning forward the page of the content displayed on the second display unit of the student information terminal when the result of the inquiry is that the user does not accept the paging-forward instruction.

It is to be noted that these general or specific aspects may be implemented using a system, a method, an integrated circuit, a computer program, or a computer-readable recording medium such as a compact disk read only memory (CD-ROM), or any combination of systems, methods, integrated circuits, computer programs and recording media.

### Advantageous Effects of Invention

According to the present invention, a user of each of the student information terminals can suspend paging forward of the content displayed on the second display unit when the user has not fully understood what has been taught in the lesson. With this, the user of each of the student information terminals can keep one's own pace and catch up with the class, which enables effective teaching.

### BRIEF DESCRIPTION OF DRAWINGS

FIG. 1 shows a concept of an educational system according to Embodiment 1.

FIG. 2 shows the appearance of a teacher information terminal according to Embodiment 1.

FIG. 3 is a block diagram showing a functional structure of the teacher information terminal according to Embodiment 1.

FIG. 4A shows the appearance of a student information terminal according to Embodiment 1.

FIG. 48 shows the appearance of the student information terminal according to Embodiment 1.

FIG. 5 is a block diagram showing a functional structure of the student information terminal according to Embodiment 1.

FIG. 6 is a flowchart showing a flow of a content display method for use in the teacher information terminal according to Embodiment 1.

FIG. 7 is a flowchart showing a flow of a content display method for use in the student information terminal according to Embodiment 1.

FIG. 8 shows a structure of a system according to Embodiment 2.

FIG. 9 shows images displayed on a first information terminal.

FIG. 10 is a block diagram showing a structure of each of the first information terminal and a second information terminal.

FIG. 11 is a view for explaining operation of the first information terminal.

FIG. 12 is a view for explaining operation of the system.

FIG. 13 is a flowchart showing a flow of the operation of the system.

FIG. 14 is a block diagram showing a structure of each of the first information terminal and the second information terminal.

FIG. 15 shows a screen of the first information terminal operating as a fourth information terminal.

FIG. 16 is a view for explaining operation of the first information terminal.

FIG. 17 is a flowchart showing a flow of the operation of the system.

FIG. 18 is a block diagram showing a structure related to an omission processing unit.

FIG. 19 is a block diagram showing a structure related to a filter.

FIG. 20 is a view or explaining operation of an omission processing unit 1Fa.

FIG. 21 is a flowchart showing a flow of the operation of the system.

FIG. 22 is a flowchart showing a flow of processing in the fourth information terminal.

FIG. 23 shows a structure of lessons which are given by a second user.

FIG. 24 shows a structure of lessons which are given by the second user.

FIG. 25 shows information stored in a storage unit.

FIG. 26 shows a second information terminal.

### DESCRIPTION OF EMBODIMENTS

### Underlying Knowledge Forming Basis of the Present Invention

The inventors found the following problem related to the educational systems described in the “Background Art” section.

In the educational systems disclosed by PTLs 1 and 2, when a teacher intends to turn a page of the content forward, the teacher operates the teacher information terminal, which triggers concurrent transmission of paging-forward instructions from the teacher information terminal to the student information terminals. Accordingly, pages of the content displayed on the display units of the respective student information terminals are turned forward concurrently. However, when there is a student who has not fully understood what has been taught in the lesson, such forcible paging forward of the content might lead the student further away from understanding the lesson.

Patent Literature (PTL) 3 discloses an educational system using the Internet (what is called an e-learning system). In this e-learning system, a user accesses a predetermined webpage using a personal computer and so on to learn things based on content displayed on the predetermined webpage. This e-learning system is a system for allowing users to each study individually at one's convenient time and is therefore different from an educational system for, like the above-described educational systems disclosed by PTLs 1 and 2, allowing users to receive the same lesson at the same time.

In order to solve the problem, an educational system according to an aspect of the present invention is: an educational system for giving a lesson based on content whose data is same between student information terminals and a teacher information terminal which wirelessly communicates with each of the student information terminals, the teacher information terminal including: a first display control unit configured to cause the content to be displayed on a first display unit; and a transmitting unit configured to transmit paging-forward instructions concurrently to the student information terminals each time a page of the content displayed on the first display unit is turned forward, the paging-forward instructions each being for instructing turning-forward of the page of the content, and the student information terminals each including: a second display control unit configured to cause same data as data of the page of the content displayed on the first display unit to be displayed on a second display unit; a receiving unit configured to receive one of the paging-forward instructions from the teacher information terminal; an inquiry unit configured to make an inquiry to a user of the student information terminal about whether or not the user accepts the paging-forward instruction when the receiving unit receives the paging-forward instruction; and a paging-forward processing unit configured to turn forward a page of the content displayed on the second display unit of the student information terminal when a result of the inquiry is that the user accepts the paging-forward instruction, and avoid turning forward the page of the content displayed on the second display unit of the student information terminal when the result of the inquiry is that the user does not accept the paging-forward instruction.

According to this aspect, a user of each of the student information terminals can suspend paging forward of the content displayed on the second display unit when the user has not fully understood what has been taught in the lesson. With this, the user of each of the student information terminals can keep one's own pace and catch up with the class, which enables effective teaching.

Furthermore, the educational system according to an aspect of the present invention may be configured such that each of the student information terminals further includes an inquiry processing unit configured to transmit the result of the inquiry to the teacher information terminal when the result of the inquiry is that the user does not accept the paging-forward instruction, and the first display control unit is configured to cause the first display unit to display, together with the content, the result of the inquiry in association with a particular one of the student information terminals when the result of the inquiry from the particular student information terminal is received by the teacher information terminal.

According to this aspect, while giving a lesson, a user of the teacher information terminal can look at the inquiry result displayed on the first display unit to know to what degree users of the student information terminals have not understood what has been taught in the lesson.

Furthermore, the educational system according to an aspect of the present invention may be configured such that the second display control unit is configured to cause the second display unit to display, together with the content, an icon indicating that the user does not accept the paging-forward instruction when the result of the inquiry is that the user does not accept the paging-forward instruction.

According to this aspect, a user of each of the student information terminals can look at the icon displayed on the second display unit to know to what degree the user oneself has not understood what has been taught in the lesson.

Furthermore, the educational system according to an aspect of the present invention may be configured such that each of the student information terminals further includes an input unit which is operated by the user, and when the page of the content is not turned forward against the paging-forward instruction, the paging-forward processing unit is configured to turn forward the page of the content displayed on the second display unit upon operation of the input unit by the user.

According to this aspect, when the page of the content is not turned forward against the paging-forward instruction, a user of the student information terminal can turn forward the page of the content displayed on the second display unit to catch up with the class.

Furthermore, the educational system according to an aspect of the present invention may be configured such that, when the receiving unit receives the paging-forward instruction, the inquiry unit is configured to avoid making the inquiry to the user about whether or not the user accepts the paging forward instruction when the page of the content displayed on the second display unit is behind the page of the content displayed on the first display unit; and make the inquiry to the user about whether or not the user accepts the paging-forward instruction when the page of the content displayed on the second display unit matches the page of the content displayed on the first display unit.

According to this aspect, no inquiry is made to a user of the student information terminal who has not caught up with the class about whether or not the user accepts the paging-forward instruction so that the user can concentrate on learning to catch up the class.

Furthermore, a teacher information terminal according to an aspect of the present invention is a teacher information terminal which wirelessly communicates with each of student information terminals, the teacher information terminal comprising: a display control unit configured to cause a display unit to display same data as data of content displayed on each of the student information terminals; and a transmitting unit configured to transmit paging-forward instructions concurrently to the student information terminals each time a page of the content displayed on the display unit is turned forward, the paging-forward instructions each being for instructing turning-forward of a page of the content displayed on a corresponding one of the student information terminals, wherein, when the transmitting unit transmits the paging-forward instructions concurrently to the student information terminals, an inquiry is made to the user of each of the student information terminals about whether or not the user accepts a corresponding one of the paging-forward instructions, and the page of the content displayed on the student information terminal is turned forward when a result of the inquiry is that the user accepts the paging-forward instruction, and the page of the content displayed on the student information terminal is not turned forward when the result of the inquiry is that the user does not accept the paging-forward instruction.

Furthermore, a student information terminal according to an aspect of the present invention is a student information terminal which wirelessly communicates with a teacher information terminal, the student information terminal comprising: a display control unit configured to cause a display unit to display same data as data of a page of the content displayed on the teacher information terminal; a receiving unit configured to receive a paging-forward instruction from the teacher information terminal each time the page of the content displayed on the teacher information terminal is turned forward, the paging-forward instruction being for instructing turning-forward of a page of the content displayed on the display unit; an inquiry unit configured to make an inquiry to a user of the student information terminal about whether or not the user accepts the paging-forward instruction when the receiving unit receives the paging-forward instruction; and a paging-forward processing unit configured to turn forward the page of the content displayed on the display unit when a result of the inquiry is that the user accepts the paging-forward instruction, and avoid turning forward the page of the content displayed on the display unit when the result of the inquiry is that the user does not accept the paging-forward instruction.

Furthermore, an integrated circuit according to an aspect of the present invention is an integrated circuit included in a teacher information terminal which wirelessly communicates with each of student information terminals, the integrated circuit comprising: a display control unit configured to cause a display unit to display same data as data of content displayed on each of the student information terminals; and a transmitting unit configured to transmit paging-forward instructions concurrently to the student information terminals each time a page of the content displayed on the display unit is turned forward, the paging-forward instructions each being for instructing turning-forward of a page of the content displayed on a corresponding one of the student information terminals, wherein, when the transmitting unit transmits the paging-forward instructions concurrently to the student information terminals, an inquiry is made to the user of each of the student information terminals about whether or not the user accepts a corresponding one of the paging-forward instructions, and the page of the content displayed on the student information terminal is turned forward when a result of the inquiry is that the user accepts the paging-forward instruction, and the page of the content displayed on the student information terminal is not turned forward when the result of the inquiry is that the user does not accept the paging-forward instruction.

Furthermore, an integrated circuit according to an aspect of the present invention is an integrated circuit included in a student information terminal which wirelessly communicates with a teacher information terminal, the integrated circuit comprising: a display control unit configured to cause a display unit to display same data as data of a page of the content displayed on the teacher information terminal; a receiving unit configured to receive a paging-forward instruction from the teacher information terminal each time the page of the content displayed on the teacher information terminal is turned forward, the paging-forward instruction being for instructing turning-forward of a page of the content displayed on the display unit; an inquiry unit configured to make an inquiry to a user of the student information terminal about whether or not the user accepts the paging-forward instruction when the receiving unit receives the paging-forward instruction; and a paging-forward processing unit configured to turn forward the page of the content displayed on the display unit when a result of the inquiry is that the user accepts the paging-forward instruction, and avoid turning forward the page of the content displayed on the display unit when the result of the inquiry is that the user does not accept the paging-forward instruction.

Furthermore, a content display method according to an aspect of the present invention is a content display method for giving a lesson based on content whose data is same between student information terminals and a teacher information terminal which wirelessly communicates with each of the student information terminals, the content display method comprising: causing a display unit to display same data as data of the content displayed on each of the student information terminals; and transmitting paging-forward instructions concurrently to the student information terminals each time a page of the content displayed on the display unit is turned forward, the paging-forward instructions each being for instructing turning-forward of a page of the content displayed on a corresponding one of the student information terminals, wherein, when the paging-forward instructions are transmitted concurrently to the student information terminals in the transmitting, an inquiry is made to the user of each of the student information terminals about whether or not the user accepts a corresponding one of the paging-forward instructions, and the page of the content displayed on the student information terminal is turned forward when a result of the inquiry is that the user accepts the paging-forward instruction, and the page of the content displayed on the student information terminal is not turned forward when the result of the inquiry is that the user does not accept the paging-forward instruction.

Furthermore, a content display method according to an aspect of the present invention is a content display method for giving a lesson based on content whose data is same between student information terminals and a teacher information terminal which wirelessly communicates with each of the student information terminals, the content display method comprising: causing a display unit to display same data as data of a page of the content displayed on the teacher information terminal; receiving a paging-forward instruction from the teacher information terminal each time the page of the content displayed on the teacher information terminal is turned forward, the paging-forward instruction being for instructing turning-forward of a page of the content displayed on the display unit; making an inquiry to a user of the student information terminal about whether or not the user accepts the paging-forward instruction when receiving the paging-forward instruction; and turning forward the page of the content displayed on the display unit when a result of the inquiry is that the user accepts the paging-forward instruction, and avoiding turning forward the page of the content displayed on the display unit when the result of the inquiry is that the user does not accept the paging-forward instruction.

It is to be noted that these general or specific aspects may be implemented using a system, a method, an integrated circuit, a computer program, or a computer-readable recording medium such as a compact disk read only memory (CD-ROM), or any combination of systems, methods, integrated circuits, computer programs, and recording media.

The educational system, the teacher information terminal, the student information terminal, the integrated circuit, and the content display method according to embodiments are specifically described below with reference to the drawings. It is to be noted that each of the embodiments described below indicates a general or specific example. The numerical values, shapes, materials, structural elements, the arrangement and connection of the structural elements, steps, the order of the steps etc., shown in the following embodiments are examples, and therefore do not limit the present invention. Furthermore, among the structural elements in the following embodiments, structural elements not recited in any one of the independent claims indicating the broadest concept are described as arbitrary structural elements.

### Embodiment 1

### Overall Structure of System

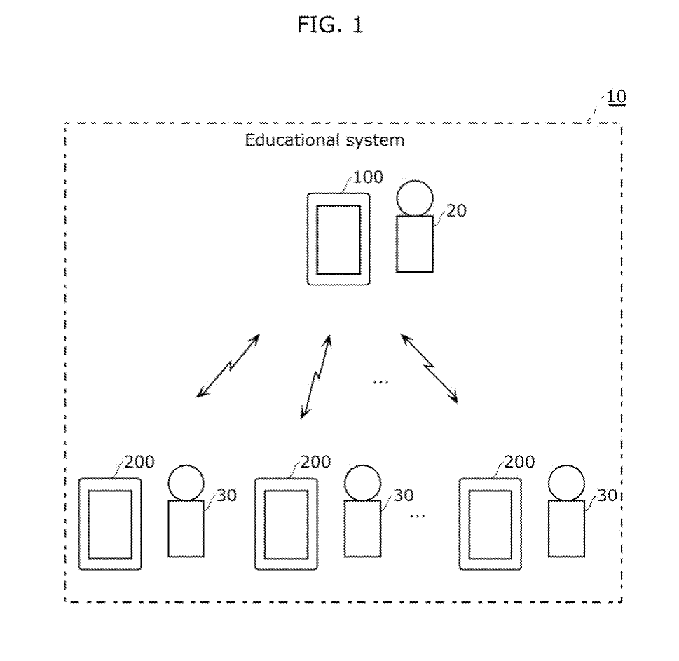

FIG. 1 shows a concept of an educational system 10 according to Embodiment 1. It is to be noted that the educational system 10 shown in FIG. 1 is applied, for example, to a class in school or the like in which a teacher and students participate.

In the educational system 10 shown in FIG. 1, a teacher information terminal 100 and student information terminals 200 are used, and the teacher information terminal 100 and each of the student information terminals 200 wirelessly communicate with each other. The teacher information terminal and the student information terminals are each tablet terminals and smart phones, for examples. The teacher information terminal 100 is operated by a user 20 that is a teacher who gives lessons. Each of the student information terminals 200 is operated by a user 30 which is a student who receives the lessons.

### Structure of Teacher Information Terminal

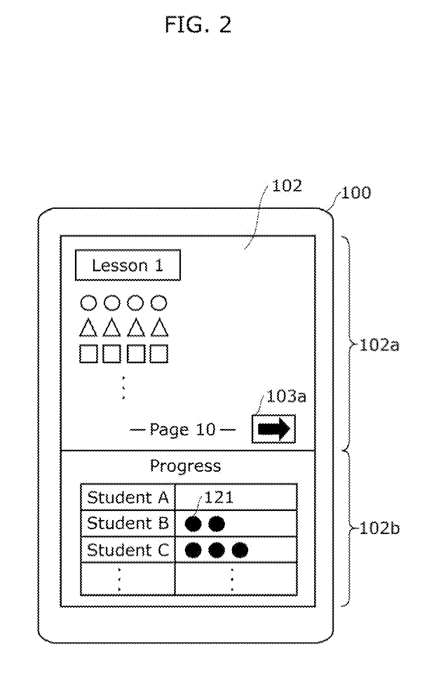

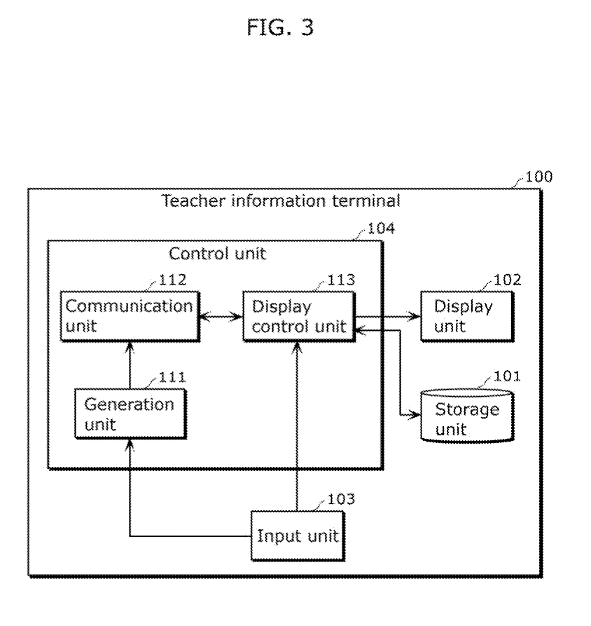

FIG. 2 shows the appearance of the teacher information terminal 100 according to Embodiment 1. FIG. 3 is a block diagram showing a functional structure of the teacher information terminal 100 according to Embodiment 1.

As shown in FIG. 3, the teacher information terminal 100 includes a storage unit 101, a display unit 102 (included in a first display unit), an input unit 103, and a control unit 104.

The storage unit 101 is a memory capable of storing data and includes a random access memory (RAM) and a nonvolatile memory, for example. In the storage unit 101, content data or the like related to content which is used in lessons is stored. The content includes an electronic text and an electronic supplementary material which are each composed of a plurality of image pages, for example.

The display unit 102 is a liquid-crystal display, for example. As shown in FIG. 2, for example, in an upper region 102a of the display unit 102, the content stored in the storage unit 101 is displayed, and in a lower region 102b of the display unit 102, a progress screen is displayed. In this progress screen, an icon 121 is displayed which indicates that one of the users 30 (e.g., student A, student B, and student C, and so on) did not accept an instruction for turning-forward of a page of the content (described hereinafter) (meaning that the student did not fully understand what had been taught for one page of the content). By checking the number of icons 121, the user 20 can know which one of the users 30 has not understood what has been taught in the lesson to what degree.

The input unit 103 is a user interface which is operated by the user 20 and is a touch panel, for example. For example, when the user 20 taps (touches) with a finger or thumb an icon or the like displayed on the display unit 102, such operation by the user 20 is obtained by the input unit 103. As shown in FIG. 2, for example, tapping an icon 103a by the user 20 with a finger or thumb causes the page of the content displayed on the display unit 102 to be turned forward and causes a generation unit 111 (described hereinafter) to generate a paging-forward instruction.

The control unit 104 includes the generation unit 111, a communication unit 112 (included in a transmitting unit), and a display control unit 113 (included in a first display control unit).

The generation unit 111 generates paging-forward instructions based on the operation of the user 20 obtained by the input unit 103. The paging-forward instructions are signals for instructing the student information terminals 200 to each turn a page of the content forward. For example, tapping the icon 103a by the user 20 with a finger or thumb causes the generation unit 111 to generate the paging-forward instructions.

The communication unit 112 transmits and receives signals, data, and so on to and from each of the student information terminals 200. The communication unit 112 transmits the generated paging-forward instructions to the student information terminals 200 concurrently, for example. Furthermore, the communication unit 112 receives an inquiry result (described hereinafter) from the student information terminals 200, for example.

The display control unit 113 includes a processor such as a digital signal processor (DSP), for example. The display control unit 113 controls image display in the display unit 102. Specifically, the display control unit 113 causes the display unit 102 to display, in the region 102a, content composed of a plurality of image pages on a per page basis based on the content data stored in the storage unit 101. For example, tapping the icon 103a by the user 20 with a finger or thumb causes the display control unit 113 to turn forward the page of the content displayed on the display unit 102.

Furthermore, when receiving, from the communication unit 112, an inquiry result from a particular student information terminal 200 among the student information terminals 200 (that is, a result indicating not accepting the paging-forward instruction), the display control unit 113 causes the progress screen to display the inquiry result in association with the particular student information terminal 200. For example, each time the communication unit 112 receives the inquiry result from the student information terminal 200 owned by the student B who is the user 30, the display control unit 113 causes the icons 121 each indicating the inquiry result to be displayed one by one in the column for the student B. By checking the number of icons 121, the user 20 can know how many times the student B has not accepted the paging-forward instructions (that is, the number of pages of the content which the student B has not fully understood).

### Structure of Student Information Terminal

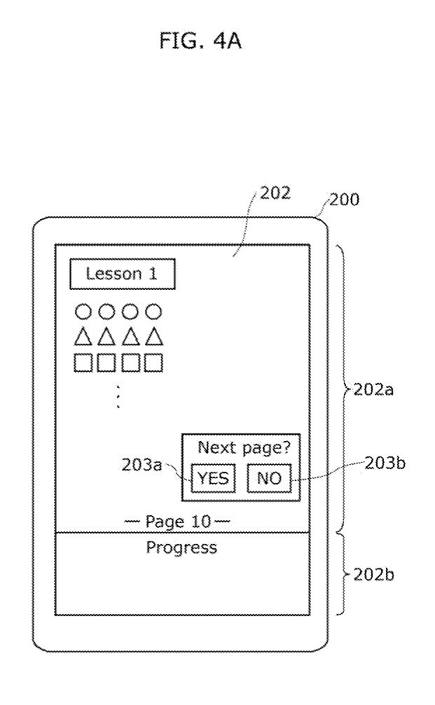

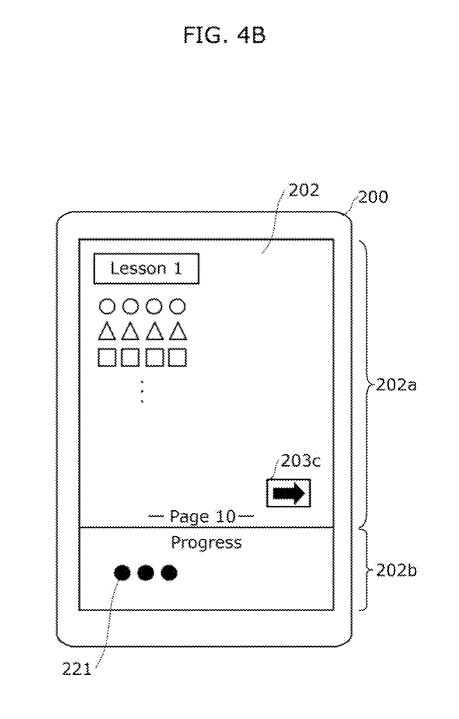

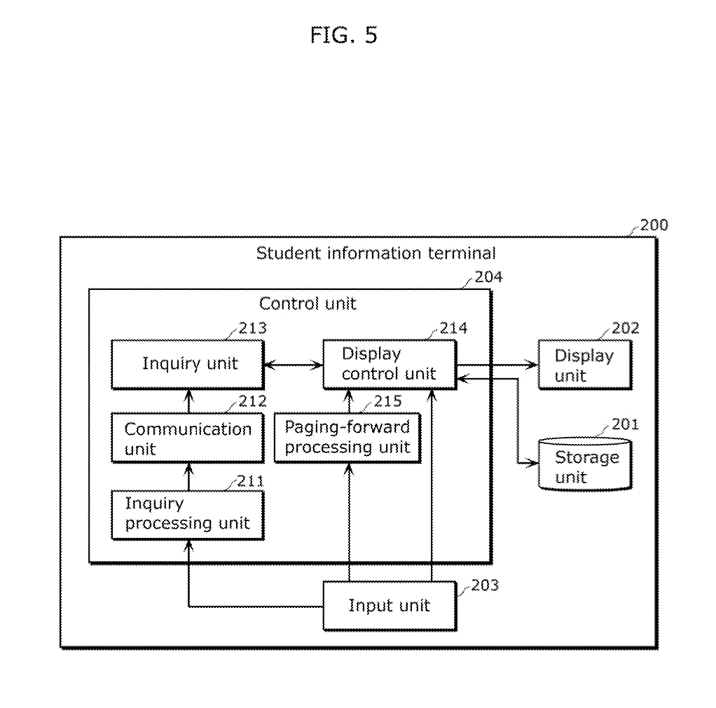

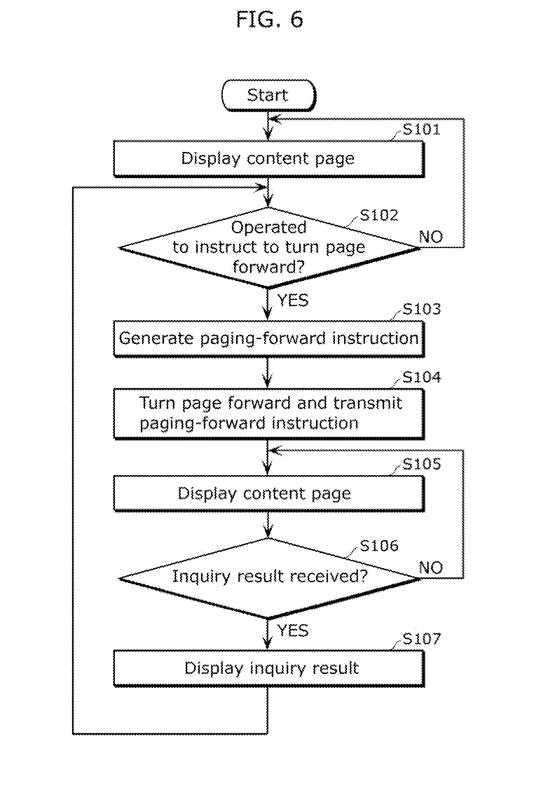

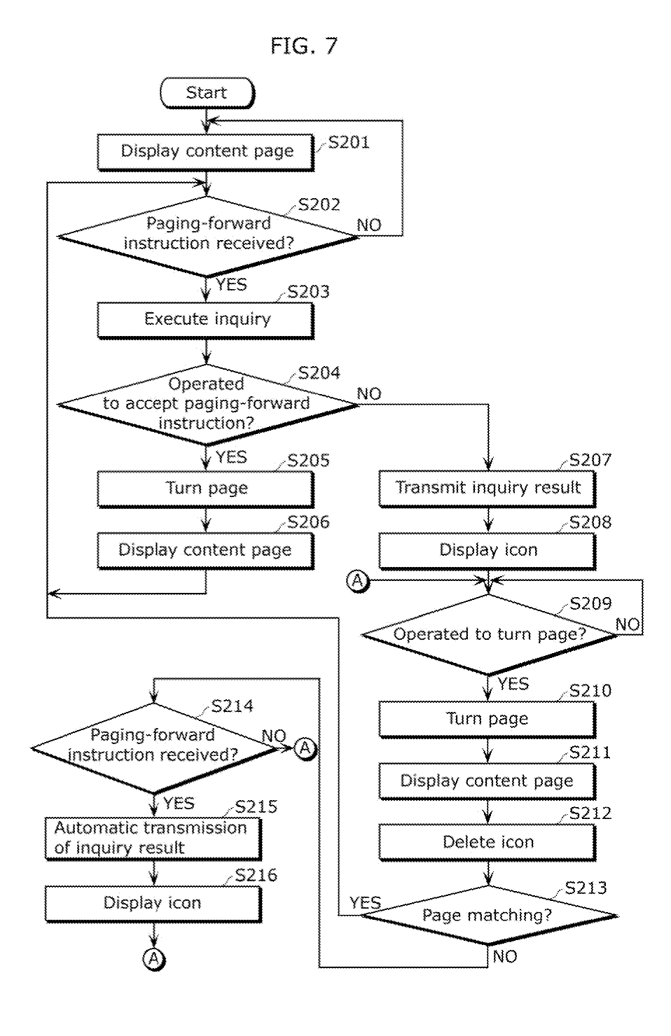

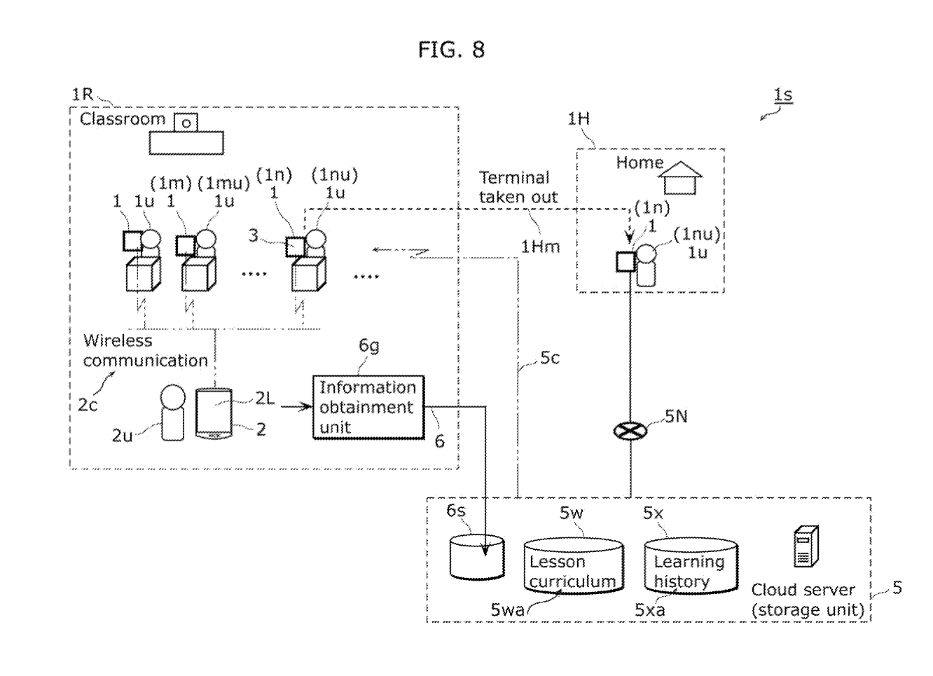

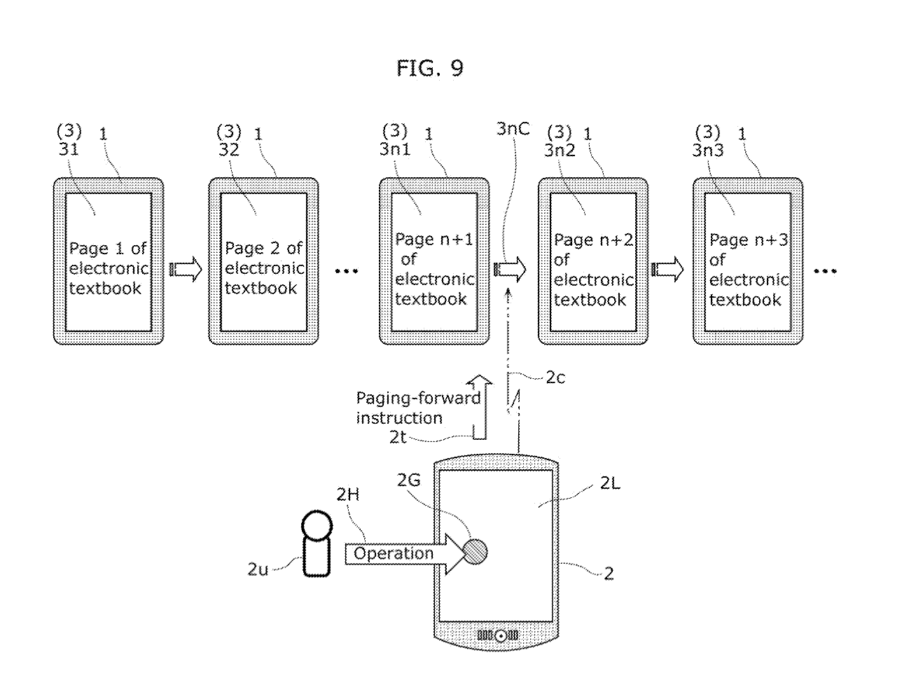

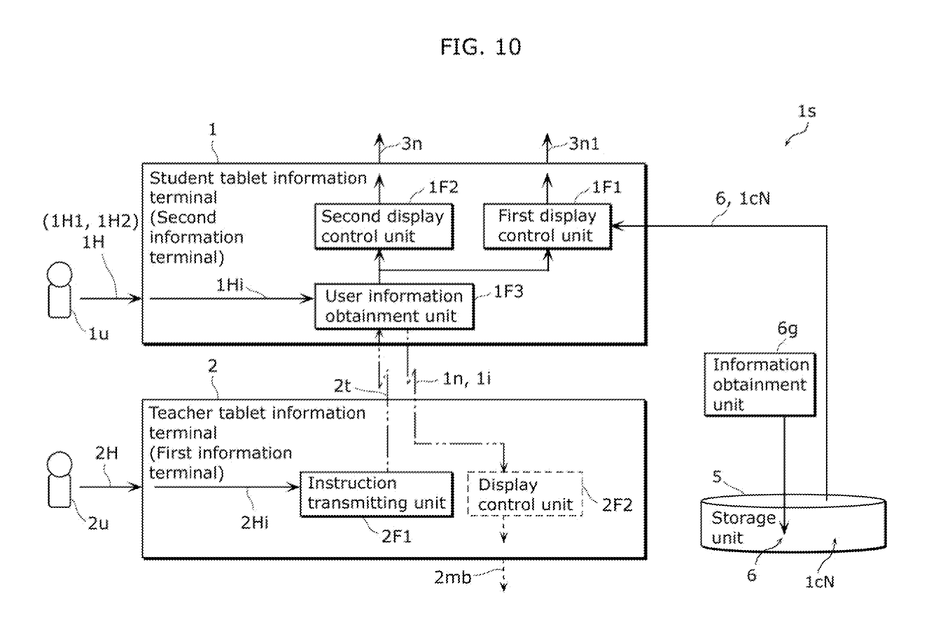

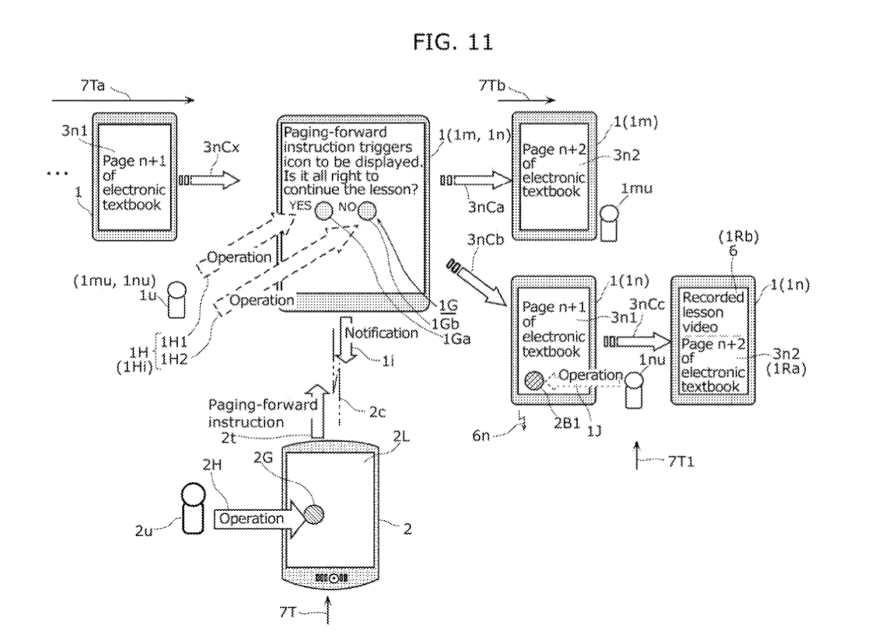

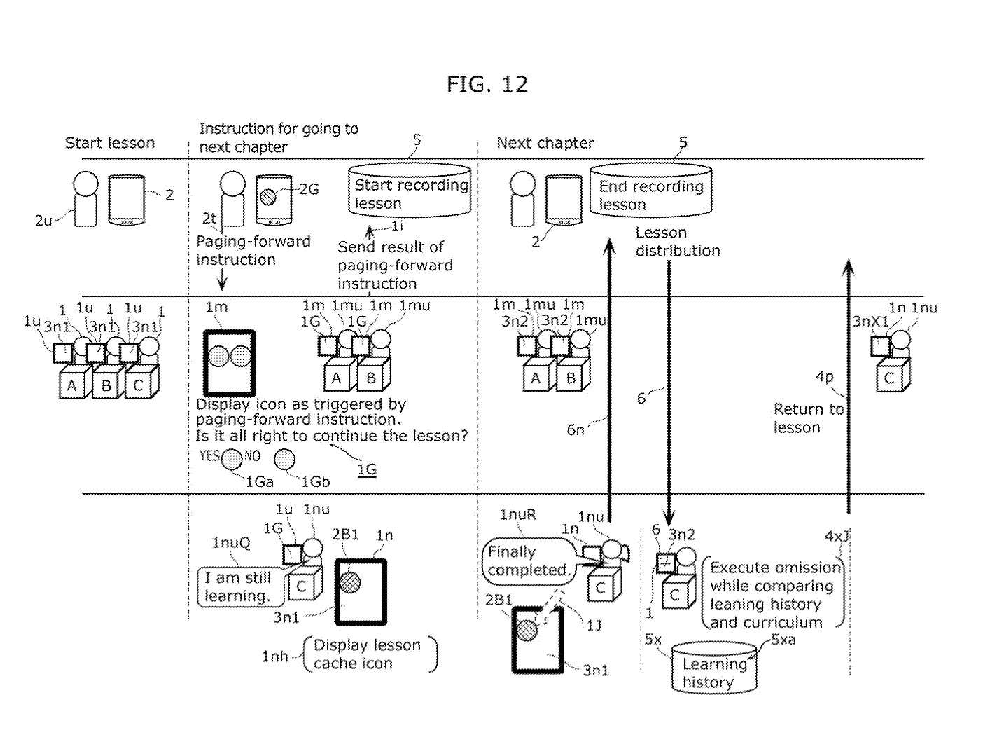

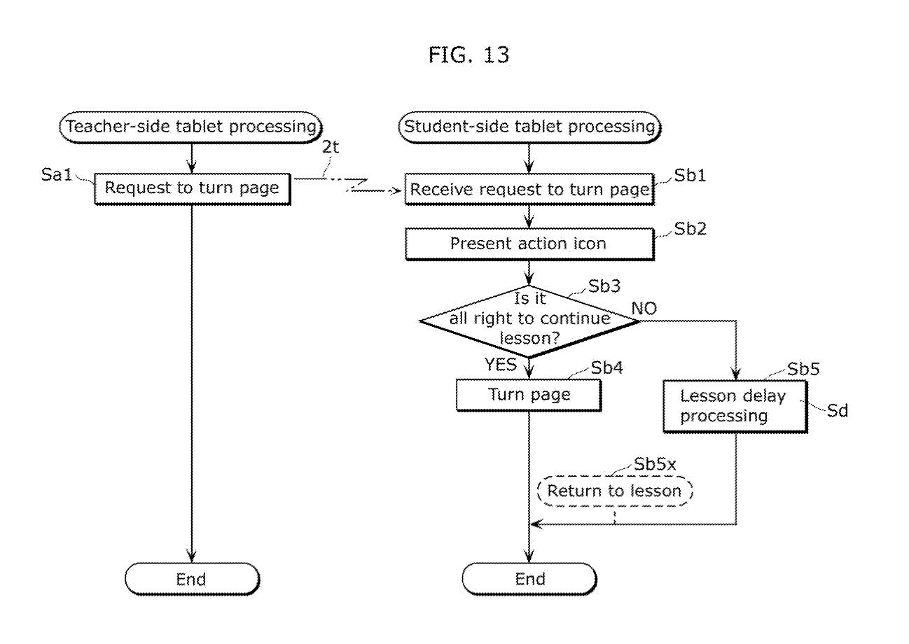

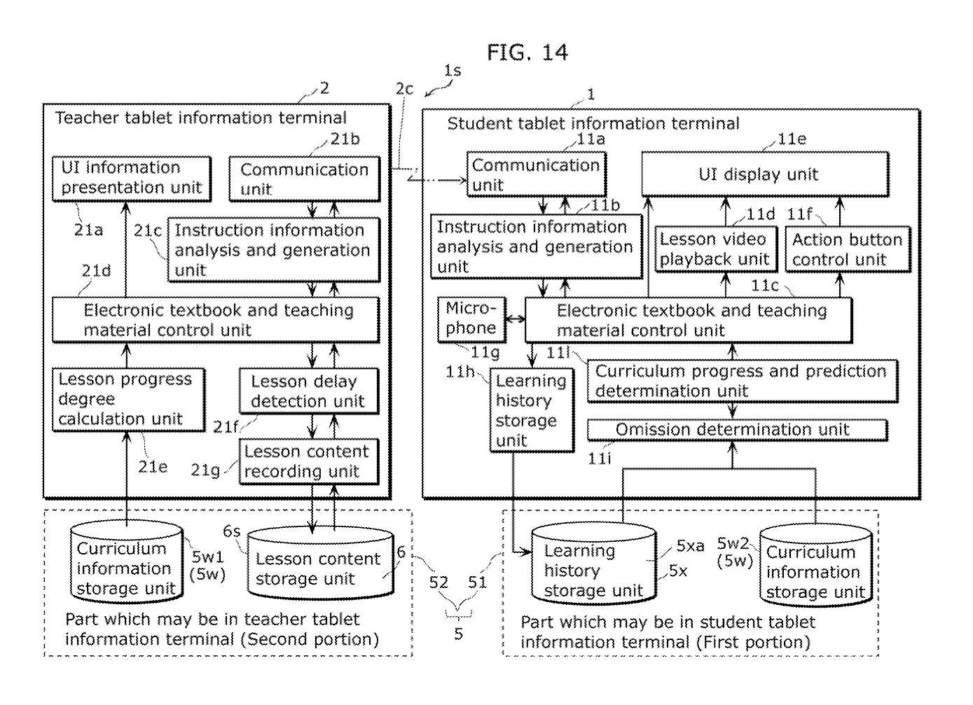

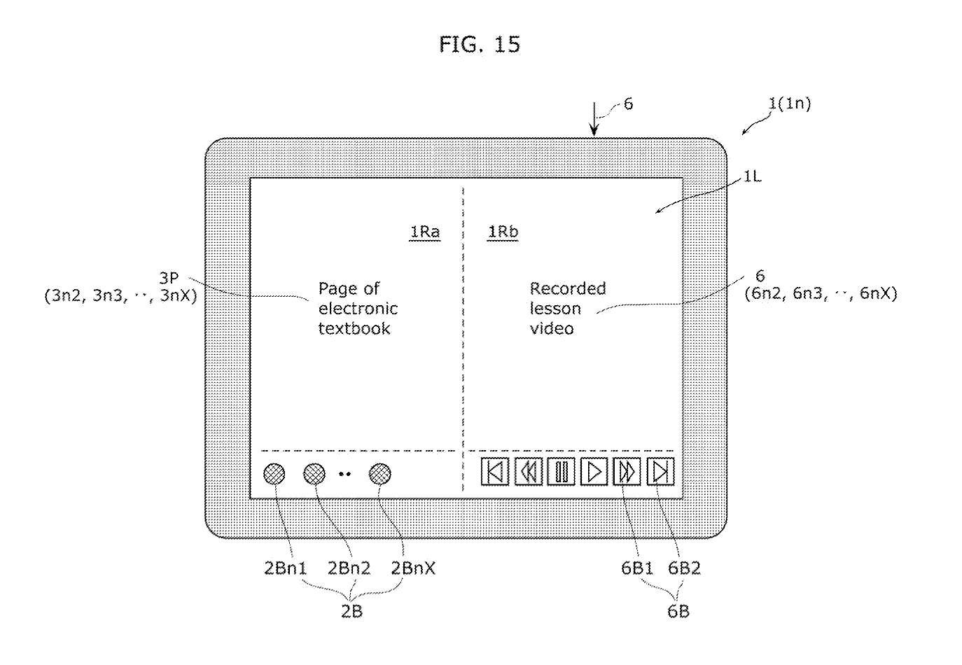

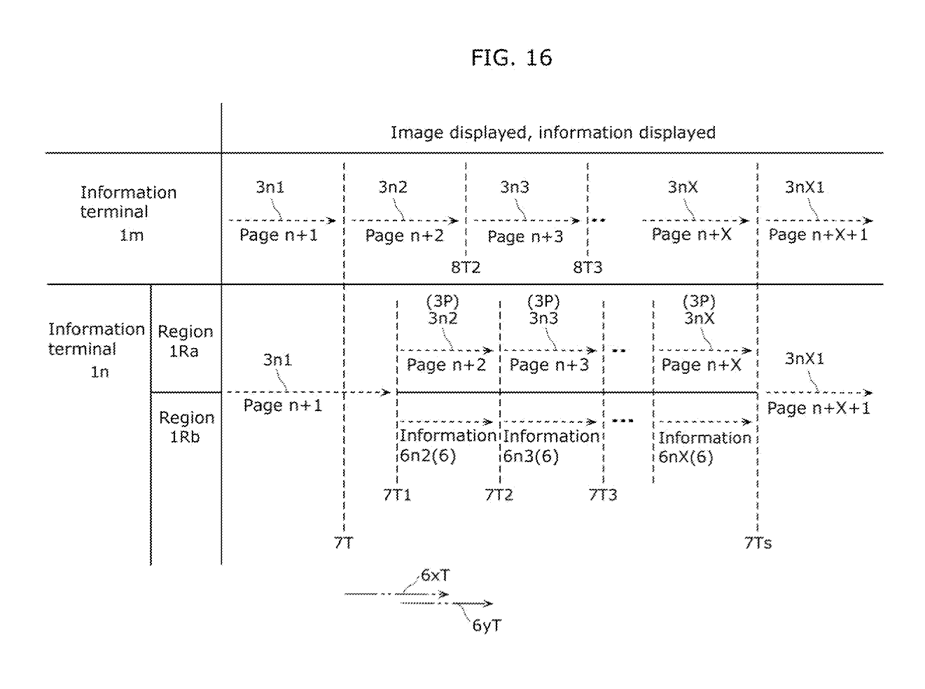

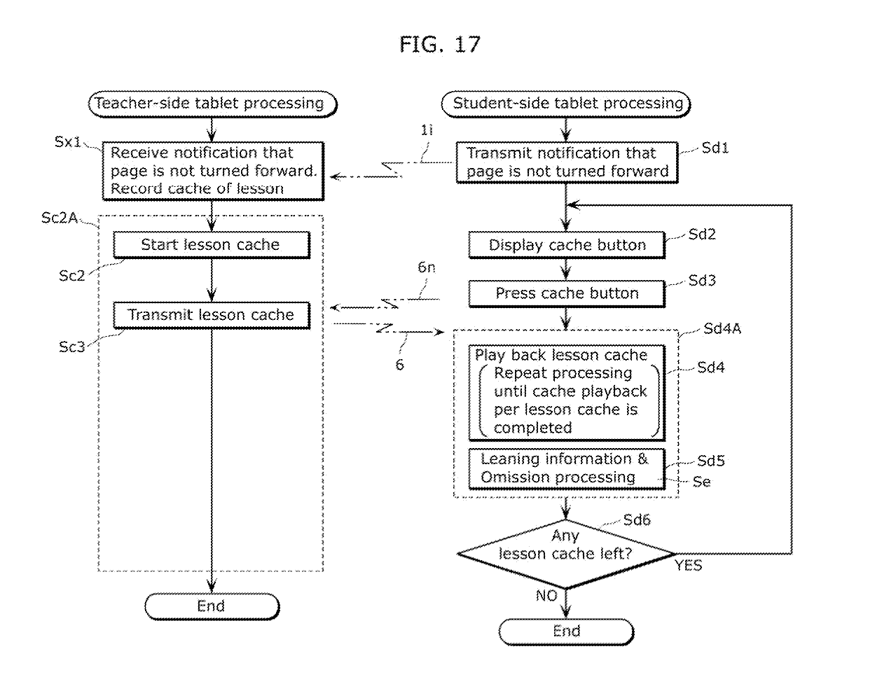

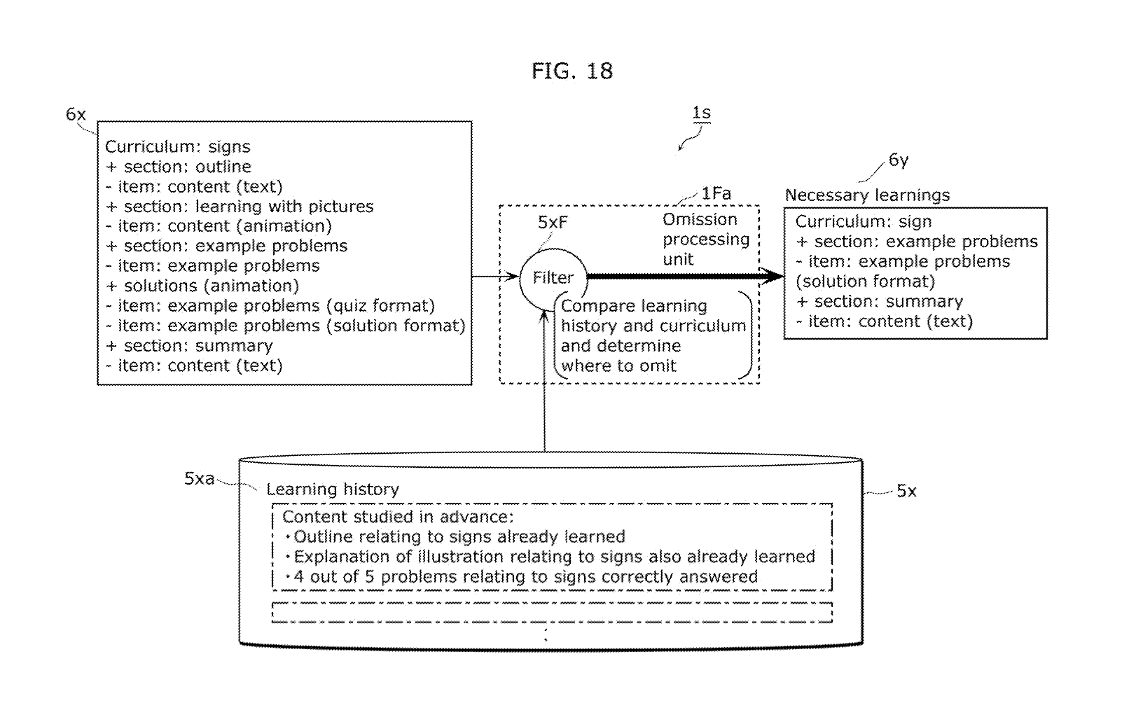

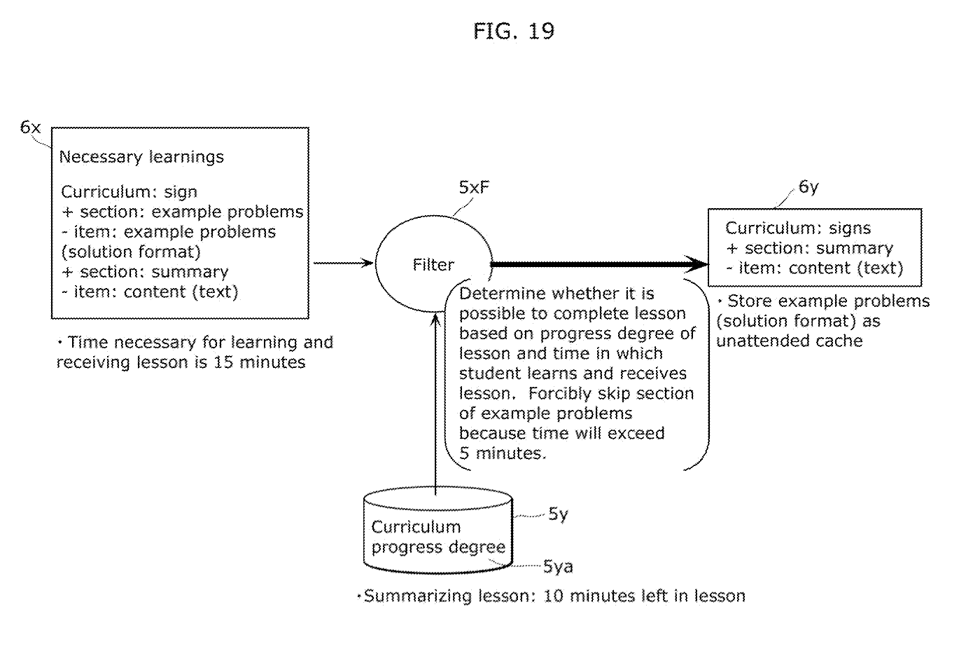

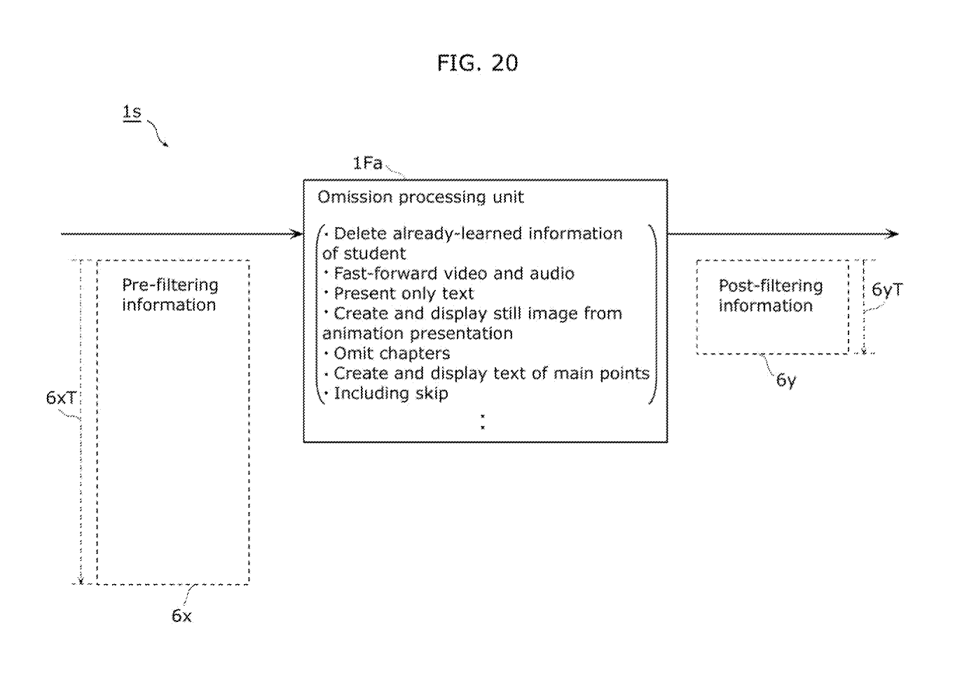

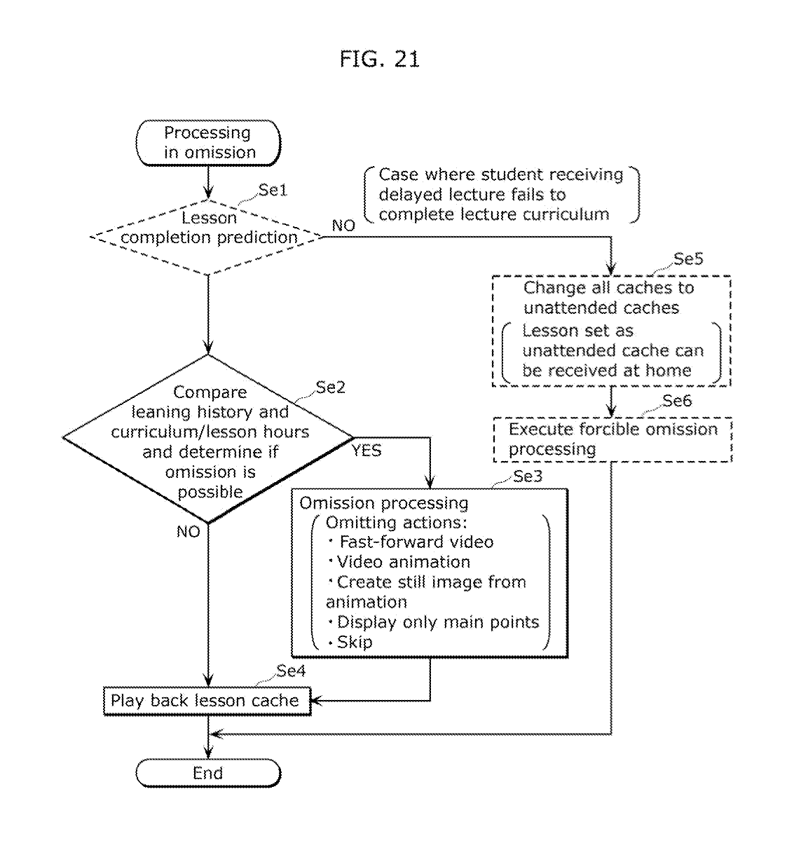

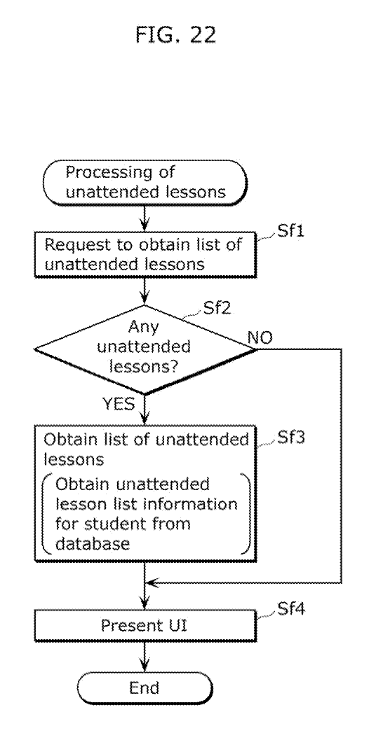

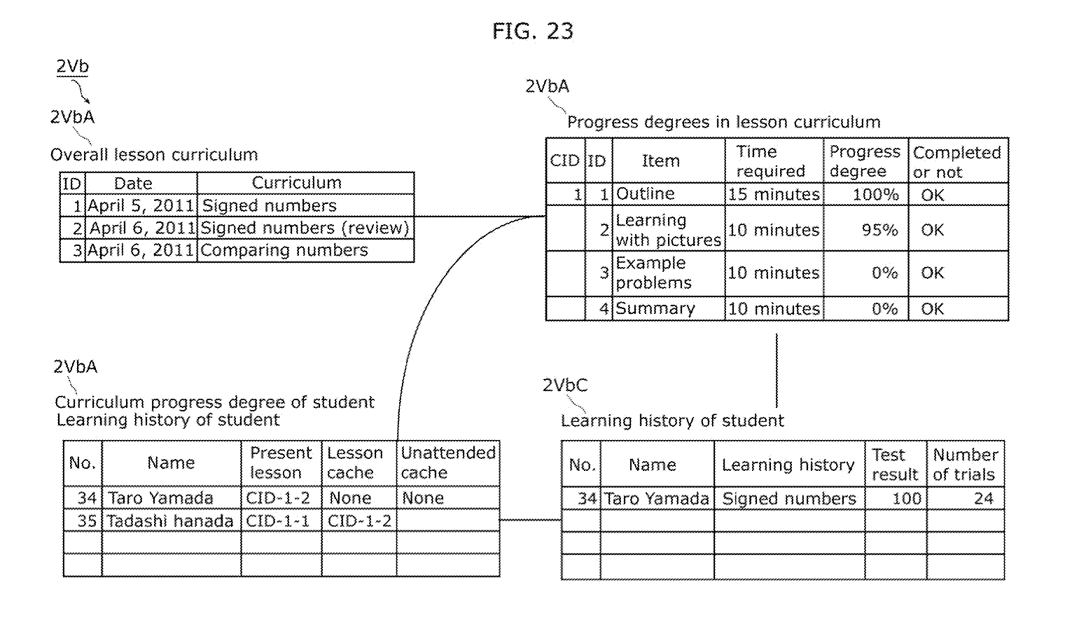

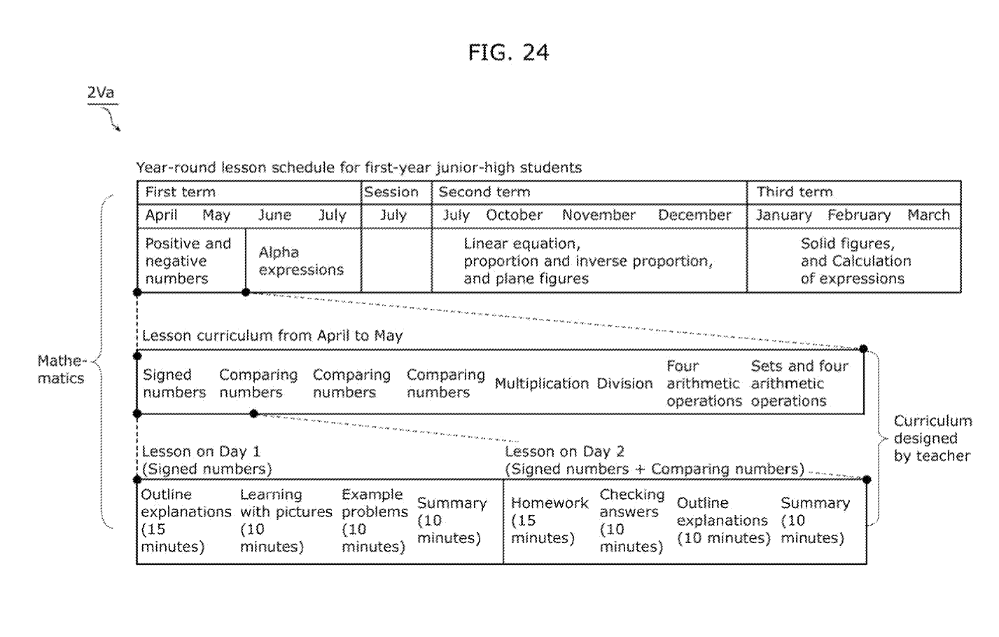

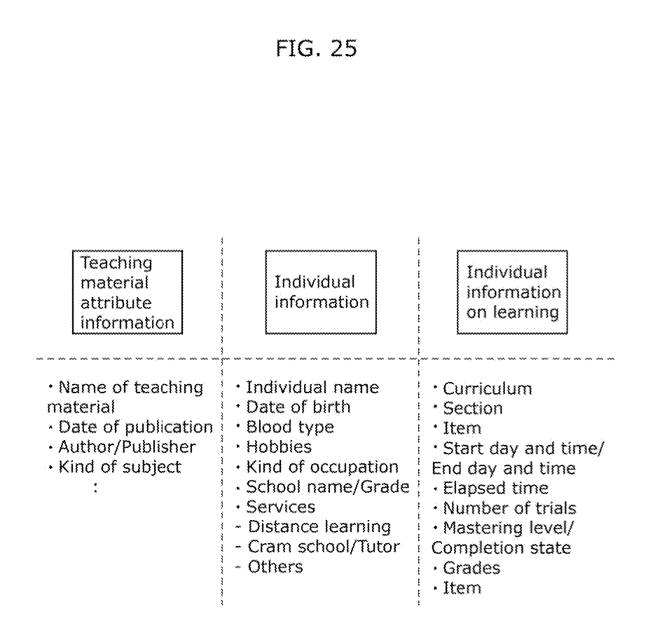

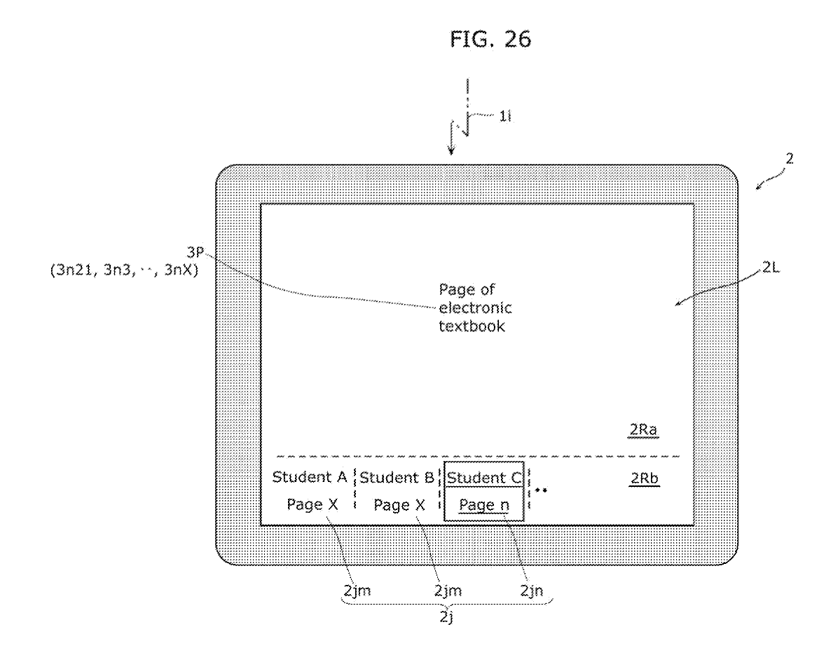

FIGS. 4A and 4B each show the appearance of the student information terminal 200 according to Embodiment 1. FIG. 5 is a block diagram showing a functional structure of the student information terminal 200 according to Embodiment 1.

As shown in FIG. 5, the teacher information terminal 200 includes a storage unit 201, a display unit 202 (included in a second display unit), an input unit 203, and a control unit 204.

The storage unit 201 is a memory capable of storing data and includes a random access memory (RAM) and a nonvolatile memory, for example. In the storage unit 201, content data or the like related to content which is used in lessons is stored. It is to be noted that the content data stored in the storage unit 201 is the same as the content data stored in the storage unit 101 of the teacher information terminal 100.

The display unit 202 is a liquid-crystal display, for example. As shown in FIGS. 4A and 4B, for example, in an upper region 202a of the display unit 202, the content stored in the storage unit 201 is displayed, and in a lower region 202b of the display unit 202, a progress screen is displayed. In this progress screen, an icon 221 is displayed which indicates that the user 30 did not accept an instruction for turning-forward of the page of the content (meaning that the user 30 did not fully understand what had been taught for one page of the content). By checking the number of icons 221, the user 30 can know to what degree the user oneself has not understood what has been taught in the lesson.

The input unit 203 is a user interface which is operated by the user 30 and is a touch panel, for example. For example, when the user 30 taps with a finger or thumb an icon or the like displayed on the display unit 202, such operation by the user 30 is obtained by the input unit 203. For example, as shown in FIG. 4A, tapping an icon 203a (i.e., an icon for making an inquiry to the user 30 about accepting the paging-forward instruction) by the user 30 with a finger or thumb causes the page of the content displayed on the display unit 202 to be turned forward. Furthermore, as shown in FIG. 4A, tapping an icon 203b (i.e., an icon for making an inquiry to the user 30 about not accepting the paging-forward instruction) by the user 30 with a finger or thumb keeps the page of the content displayed on the display unit 202 from being turned forward and causes the inquiry result (that is, a result indicating not accepting the paging-forward instruction) to be transmitted to the teacher information terminal 100.

Furthermore, as shown in FIG. 4B, when the page of the content is not turned forward against the paging-forward instruction, an icon 203c is displayed on the display unit 202. Tapping the icon 203c by the user 30 with a finger or thumb causes the page of the content displayed on the display unit 202 to be turned forward.

The control unit 204 includes an inquiry processing unit 211, a communication unit 212 (included in a receiving unit), an inquiry unit 213, a display control unit 214 (included in a second display control unit), and a paging-forward processing unit 215.

When the inquiry result indicates not accepting the paging-forward instruction, the inquiry processing unit 211 instructs the communication unit 212 to transmit, to the teacher information terminal 100, the inquiry result obtained by the input unit 203.

The communication unit 212 transmits and receives signals, data, and so on to and from the teacher information terminal 100. The communication unit 212 transmits the inquiry result to the teacher information terminal 100 based on the instruction from the inquiry processing unit 211, for example. Furthermore, the communication unit 212 receives the paging-forward instruction from the teacher information terminal 100, for example.

The inquiry unit 213 makes an inquiry to the user 30 about whether or not the user accepts the paging-forward instruction when the communication unit 212 receives the paging-forward instruction. Specifically, the inquiry unit 213 instructs the display control unit 214 to cause the display unit 202 to display the icons 203a and 203b for making an inquiry to the user 30 about whether or not the user accepts the paging-forward instruction.

It is to be noted that, in the case where the page of the content displayed on the display unit 202 is behind the page of the content displayed on the display unit 102 of the teacher information terminal 100 at the time when the communication unit 212 receives the paging-forward instruction, the inquiry unit 213 does not make an inquiry to the user 30 about whether or not the user accepts the paging-forward instruction. In this case, the inquiry processing unit 211 instructs the communication unit 212 to automatically transmit the inquiry result (that is, a result indicating not accepting the paging-forward instruction) to the teacher information terminal 100. On the other hand, in the case where the page of the content displayed on the display unit 202 matches the page of the content displayed on the display unit 102 of the teacher information terminal 100 at the time when the communication unit 212 receives the paging-forward instruction, the inquiry unit 213 makes an inquiry to the user 30 about whether or not the user accepts the paging-forward instruction.

The paging-forward processing unit 215 determines whether or not to turn the page of the content forward based on the inquiry result obtained by the input unit 203. Specifically, when the communication unit 212 receives the paging-forward instruction, tapping the icon 203a by the user 30 with a finger or thumb (that is, the inquiry result is a result indicating accepting the paging-forward instruction) causes the paging-forward processing unit 215 to turn forward the page of the content displayed on the display unit 202. On the other hand, when the communication unit 212 receives the paging-forward instruction, tapping the icon 203b by the user 30 with a finger or thumb (that is, the inquiry result is a result indicating not accepting the paging-forward instruction), the paging-forward processing unit 215 does not turn forward the page of the content displayed on the display unit 202, Furthermore, when the page of the content is not turned forward against the paging-forward instruction, tapping the icon 203c by the user 30 with a finger or thumb causes the paging-forward processing unit 215 to turn forward the page of the content displayed on the display unit 202.

The display control unit 214 includes a processor such as a digital signal processor (DSP), for example. The display control unit 214 controls image display in the display unit 202. Specifically, the display control unit 214 causes the display unit 202 to display, in the region 202a, content composed of a plurality of image pages on a per page basis based on the content data stored in the storage unit 201.

Furthermore, the display control unit 214 controls content display in the display unit 202 based on an instruction given from the paging-forward processing unit 215. For example, tapping the icon 203a (or the icon 203c) by the user 30 with a finger or thumb causes the display control unit 214 to control the content display in the display unit 202 so that a page of the content is turned forward. Tapping the icon 203b by the user 30 with a finger or thumb causes the display control unit 214 to control the content display in the display unit 202 so that a page of the content is not turned forward.

Furthermore, when the user 30 taps the icon 203b with a finger or thumb, the display control unit 214 causes the display unit 202 to display, in the progress screen, the icon 221 indicating not accepting the paging-forward instruction. It is to be noted that when the page of the content displayed on the display unit 202 is behind the page of the content displayed on the display unit 102 of the teacher information terminal 100, the display control unit 214 causes, based on an instruction given from the inquiry unit 213, the icons 221 to be displayed one by one in the progress screen each time, the communication unit 212 receives a paging-forward instruction. By checking the number of icons 221, the user 30 can know to what degree the user oneself has not understood what has been taught in the lesson.

In addition, each time a page of the content is turned forward as a result of tapping the icon 203c by the user 30 with a finger or thumb, the display control unit 214 deletes the icons 221 one by one. When the page of the content displayed on the display unit 202 has come to match the page of the content displayed on the display unit 102 of the teacher information terminal 100, all the icons 221 are deleted from the progress screen.

### Content Display Method

Next, a content display method for use in the above-described educational system 10 is described with reference to FIGS. 6 and 7. FIG. 6 is a flowchart showing a flow of the content display method for use in the teacher information terminal 100 according to Embodiment 1. FIG. 7 is a flowchart showing a flow of the content display method for use in the student information terminal 200 according to Embodiment 1.

At a start of a lesson, the display unit 102 of the teacher information terminal 100 and the display units 202 of the respective student information terminals 200 display the same page of the same content (e.g., the first page of an electronic text) (S101, S201). The user 20 gives a lesson while referring to the page of the content displayed on the display unit 102. Each of the users 30 receives the lesson while referring to the page of the content displayed on the display unit 202.

As the lesson proceeds, when the user 20 intends to turn a page of the content forward, the user 20 taps with a finger or thumb the icon 103a (see FIG. 2) displayed on the display unit 102 of the teacher information terminal 102 (YES in S102). Accordingly, the generation unit 111 generates paging-forward instructions (S103), and the communication unit 112 transmits the generated paging-forward instructions to the student information terminals 200 concurrently (S104). At the same time, the display control unit 113 turns forward the page of the content displayed on the display unit 102 (S104). As a result, a next page of the content (e.g., the second page of the electronic text) is displayed on the display unit 102 (S105).

When the communication unit 212 of the student information terminal 200 receives a paging-forward instruction (YES in S202), the inquiry unit 213 makes an inquiry to the user 30 about whether or not the user accepts the paging-forward instruction (S203). Thus, the icons 203a and 203b (see FIG. 4A) for making an inquiry to the user 30 about whether or not the user accepts the paging-forward instruction are displayed on the display unit 202.

When the user 30 has fully understood what has been taught in the lesson, the user 30 taps with a finger or thumb the icon 203a for inputting an inquiry result indicating accepting the paging-forward instruction (YES in S204). In response to this inquiry result, the paging-forward processing unit 215 turns forward the page of the content displayed on the display unit 202 (S205). As a result, a next page of the content (e.g., the second page of the electronic text) is displayed on the display unit 202 (S206). Afterward, the above-described Step S202 is executed again in the student information terminal 200.

On the other hand, when the user 30 has not fully understood what has been taught in the lesson, the user 30 taps with a finger or thumb the icon 203b for inputting an inquiry result indicating not accepting the paging-forward instruction (NO in S204). In response to this inquiry result, the paging-forward processing unit 215 does not turn forward the page of the content displayed on the display unit 202. As a result, the current page of the content (e.g., the first page of the electronic text) continues to be displayed on the display unit 202. In this case, the communication unit 212 transmits, to the teacher information terminal 100, the inquiry result indicating not accepting the paging-forward instruction (S207). Furthermore, on the basis of an instruction given from the inquiry unit 213, the display control unit 214 causes the icons 221 (see FIG. 4B) to be displayed one by one in the progress screen (S208).

When the communication unit 112 of the teacher information terminal 100 receives an inquiry result (YES in S106), the display control unit 113 associates the inquiry result with the student information terminal 200 to thereby cause the icons 121 (see FIG. 2) to be displayed one by one in the progress screen (S107). Afterward, the above-described Step S102 is executed again in the teacher information terminal 100.

When the page of the content is not turned forward against the paging-forward instruction in the student information terminal 200, the user 30 stays behind others in the class and keeps learning to understand what is on the page of the content displayed on the display unit 202 (e.g., the first page of the electronic text). When the user 30 gains a full understanding of what is on the page of the content, then the user 30 taps with a finger or thumb the icon 203c displayed on the display unit 202 (YES in S209). Accordingly, the paging-forward processing unit 215 turns forward the page of the content displayed on the display unit 202 (S210), with the result that a next page of the content (e.g., the second page of the electronic text) is displayed on the display unit 202 (S211). In addition, when the page of the content is turned forward, the display control unit 214 deletes the icons 221 one by one in the progress screen (S212).

When, through such turning forward of the page of the content, the page of the content displayed on the display unit 202 has come to match the page of the content displayed on the display unit 102 of the teacher information terminal 100 (YES in S213), the above-described Step S202 is executed again.

On the other hand, when the page of the content displayed on the display unit 202 is behind the page of the content displayed on the display unit 102 of the teacher information terminal 100 (NO in S213), the following processing is performed. Specifically, when the communication unit 212 receives a paging-forward instruction (YES in S214), the inquiry unit 213 does not make an inquiry to the user 30 about whether or not the user accepts the paging-forward instruction, and the communication unit 212 automatically transmits the inquiry result (that is, a result indicating not accepting the paging-forward instruction) to the teacher information terminal 100 (S215). On the basis of an instruction given from the inquiry unit 213, the display control unit 214 causes the icons 221 to be displayed one by one in the progress screen (S216) Afterward, until the page of the content displayed on the display unit 202 comes to match the page of the content displayed on the display unit 102 of the teacher information terminal 100, the above-described Steps S209 to S216 are repeatedly executed.

### Effects

As described above, when the user 30 has not fully understood what has been taught in the lesson, it is possible to suspend paging forward of the content displayed on the display unit 202 in this embodiment. With this, the user 30 can keep one's own pace and catch up with the class, which enables effective teaching.

### Variations Etc.

Although the display units 102 and 202 are each configured to display content including plural pieces of image data in this embodiment, the display units 102 and 202 may each be configured to display content including plural pieces of video data. In this case, turning a page forward means transmitting a chapter of video, for example.

Although the teacher information terminal 100 and the student information terminal 200 are configured to include the display unit 102 and the display unit 202, respectively, in this embodiment, these display unit 102 and display unit 202 may be configured as external devices of the teacher information terminal 100 and the student information terminal 200, respectively.

Although the user 20 is a teacher at school or the like in this embodiment, the user 20 may be a lecturer at seminar or the like. Furthermore, although the user 30 is a student at school or the like in this embodiment, the user 30 may be a participant who attends a seminar or the like.

Although the storage units 101 and 201 are each configured to store content in this embodiment, the structure may be such that content is stored into an external server (not shown). In this case, the content read from the server via a network is displayed on each of the display units 102 and 202.

In this embodiment, when the student information terminal 200 receives a paging-forward instruction, an inquiry is made to the user 30 about whether or not the user accepts the paging-forward instruction, before the page of the content displayed on the display unit 202 is turned forward. Instead of such configuration, an inquiry may be made to the user 30 about whether or not the user accepts the paging-forward instruction, after the page of the content displayed on the display unit 202 is turned forward. In this case, an icon or the like (not shown) for turning back the page of the content is displayed on the display unit 202, for example. When the user 30 has not fully understood what has been taught in the lesson, tapping this icon with a finger or thumb causes the content displayed on the displayed unit 202 to return to a previous page (that is, substantially no paging forward through the content).

In addition, the structure may be such that the lesson given by the user 20 is recorded by a video camera or the like and when the user 30 learns to catch up with the class, the recoded video is partially omitted and displayed on the display unit 202. In this case, the storage unit 201 stores the recorded video as video data. The control unit 204 includes an omission processing unit (not shown) for partially omitting the video data stored in the storage unit 201 (for example, playing back the video data at high speed). Furthermore, the icon 221 functions as a cache button that, when tapped, starts playing back partially-omitted video data associated with the page of the content.

When the user 30 taps the icon 203b with a finger or thumb (No in S204) and the user 30 taps the icon 221 with a finger or thumb, the display control unit 214 causes the display unit 202 to display the partially-omitted video data. By watching this partially-omitted video data, the user 30 can check again what the user has not understood enough in the lesson.

It is to be noted that, instead of the recorded video, pages of content (e.g., an electronic supplementary material) used in the lesson can be partially omitted and displayed on the display unit 202. In this case, it is also possible that content of an electronic text and partially omitted content of an electronic supplementary material etc., are displayed on a double screen in the region 202a of the display unit 202 at the same time.

### Embodiment 2

An educational system 1s described below includes student information terminals (first information terminals) 1 and a teacher information terminal (second information terminal) 2 which wirelessly communicates with each of the student information terminals 1 (see FIGS. 8, 9, and 10 etc.).

The teacher information terminal 2 transmits first information 2t to each of the student information terminals 1 via wireless communication 2c.

Each of the student information terminals 1 includes a first display control unit 1F1. This first display control unit 1F1 displays, on the student information terminal 1, an image 3n2 on page n+2 that is an image on the page next to an image 3n1 on page n+1 during a period after transmission of the first information 2c (a period 7Tb in FIG. 11 and a period in the second column in FIG. 16). By doing so, the first display control unit 1F1 changes an image 3 (see FIG. 9) displayed on the student information terminal 1 from the original image 3n1 to the image 3n2 on the next page (that is, turning a page forward). The image 3n1 on page n+1 is an image displayed on the student information terminal 1 during a period before the transmission of the first information 2t (a period 7Ta in FIG. 11 and a period in the first column in FIG. 16).

Each of the student information terminals 1 further includes a second display control unit 1F2 and a user information obtainment unit 1F3. The second display control unit 1F2 maintains the original image 3n1 as the image 3 displayed on the student information terminal 1 during the above period after the transmission of the first information 2t (the period 7Tb in FIG. 11 and the period in the second column in FIG. 16) (that is, no turning of pages forward). The user information obtainment unit 1F3 obtains second information 1Hi (see FIGS. 10 and 11) and controls each of the first display control unit 1F1 and the second display control unit 1F2 based on the obtained second information 1Hi. Specifically, the user information obtainment unit 1F3 causes the first display control unit 1F1 to perform the above-described display changeover when the student information terminal 1 is determined to be the first terminal (a third information terminal 1m in FIGS. 11 and 12), and causes the second display control unit 1F2 to maintain the original image 3n1 as displayed, when the student information terminal 1 is determined to be the second terminal (a fourth information terminal 1n in FIGS. 11 and 12).

By doing so, in the first information terminal 1 (the fourth information terminal 1n) determined to be the second terminal, the display changeover (Sb4 in FIG. 13) is avoided to maintain the original image 3n1 as displayed.

Thus, in this embodiment, the system 1s which performs more appropriate operation can be provided.

It to be noted that the above-described structure causes each of the student information terminals 1 to obtain the second information 1Hi and perform processing based on the second information 1Hi. This makes it possible to avoid complicated processing in the student information terminal 1 and the teacher information terminal 2.

It is to be noted that the system 1s may further include an information obtainment unit 6g and a storage unit 5 (see FIGS. 8 and 10). The information obtainment unit 6g obtains information 6 (e.g., information such as video, audio, and images of supplementary materials of the lesson) other than the displayed image, which is perceived by a first user 1mu of a student information terminal 1m during a period (a period from a time point 7T to a time point 8T2 in. FIG. 16) in which an image on a page (e.g., the image 3n2 on page n+2) following the image on the original page (e.g., the image 3n1 on page n+1) is displayed on the student information terminal 1m operating as the first terminal (the third information terminal 1m). The storage unit 5 stores the information 6 obtained by the information obtainment unit 6g, during a period (a period from a time point 7T1 to a time point 7T2 in FIG. 16) in which a subsequent image (e.g., the image 3n2 on page n+2) is displayed on the student information terminal 1n operating as the second terminal (the fourth information terminal 1n). It is to be noted that a starting point in time (the time point 7T1) of the above-mentioned period (the period from the time point 7T1 to the time point 7T2 in FIG. 16) in the student information terminal 1n is after a starting point in time (the time point 7T) of the above-mentioned period (the period from the time point 7T to the time point 8T2 in FIG. 16) in the student information terminal 1m. The second display control unit 1F2 in the student information terminal 1n displays an image on a subsequent page (e.g., the image 3n2 on page n+2) during the above-mentioned period (the period from the time point 7T1 to the time point 7T2 in FIG. 16) and plays back the information 6 (information 6n2 in FIG. 16) stored in the storage unit 5.

Furthermore, the second display control unit 1F2 includes an omission processing unit 1Fa which converts the information 6 (the information 6n2) stored in the storage unit 5 from information 6x to information 6y. As shown in FIG. 20, time 6xT required to play back the information 6x having not yet undergone the conversion is longer than time 6yT required to play back the information 6y resulting from the conversion. When the information 6 (the information 6n2) stored in the storage unit 5 is played back, not the information 6x having not yet undergone the conversion, but the information 6y resulting from the conversion, may be played back.

The teacher information terminal 2 may further include an instruction transmitting unit 2F1 and a display control unit 2F2 (see FIG. 10). The instruction transmitting unit 2F1 transmits the first information 2t via the wireless communication 2c. When the first information 2t is transmitted (the time point 7T), the display control unit 2F2 obtains, from each of the student information terminals 1, third information 1i (see FIGS. 11 and 12) indicating whether or not a changeover 3nCa (see FIG. 11) to an image on the next page (e.g., the image 3n2 on page n+2) has been performed. On the basis of the obtained third information 1i, the display control unit 2F2 displays a graphic object 2j (see FIG. 26) indicating whether or not the changeover 3nCa has been performed in the student information terminal 1.

It is to be noted that the graphic object 2j includes a graphic object 2jm corresponding to the student information terminal 1m in which the changeover 3nCa has been performed and a graphic object 2jn corresponding to the student information terminal 1n in which the changeover 3nCa has not been performed. A number included in the graphic object 2jm (schematically shown as a symbol “X” in FIG. 26) is a relatively large number such as a page number of the image displayed on the student information terminal 1m in which the changeover 3nCa has been performed, and indicates that the changeover 3nCa has been performed. Meanwhile, a number included in the graphic object 2jn (schematically shown as a symbol “n” in FIG. 26) is a relatively small number and indicates that the changeover 3nCa has not been performed.

The following describes the system 1s in detail.

### Structure of System 1s

FIG. 8 shows a structure of the system 1s according to Embodiment 2.

The system 1s includes the first information terminals 1 and the second information terminal 2.

The first information terminals 1 and the second information terminal 2 are each tablet terminals and smart phones, for examples. Each of the first information terminals 1 and the second information terminal 2 are carried by a first user 1u and a second user 2u, respectively, and present information to the first user 1u and the second user 2u, respectively, and perform the wireless communication 2c with other devices and so on.

In this system 1s, there are three or more users including the first users 1u of the first information terminals and the second user 2u of the second information terminal 2.

The first information terminal 1 displays the image 3 to present this image 3 to the first user 1u.

FIG. 9 shows images 3 displayed on the first information terminal 1.

These images 3 are images on pages included in an electronic textbook or the like.

The first information terminal 1 displays an image 31 on the first page first and an image 32 on the second page secondly among these images 3, thus displaying the images 3 in sequence (see the page changeover 3nC in FIG. 9).

FIG. 10 is a block diagram showing a structure of each of the first information terminal 1 and the second information terminal 2.

The first information terminal 1 includes the first display control unit 1F1.

It is to be noted that each functional block included in the first information terminal 1 is implemented, for example, by a program being executed by a computer included in the first information terminal 1.

The same applies to each functional block included in the second information terminal 2.

FIG. 11 is a view for explaining operation of the first information terminal 1.

By the first display control unit 1F1, the image 3n2 on page n+2 that is an image on the page next to the image 3n1 on page n+1 is displayed during the period 7Tb after the time point 7t.

Here, the time point 7T is a point in time at the end of the period 7Ta during which the image 3n1 on page n+1 is displayed on the first information terminal 1.

In addition, n indicates an integer of at least 0.

The first display control unit 1F1 changes the displayed image 3 from the image 3n1 on page n+1 to the image 3n2 on page n+2 at the time point 7T.

Performing this changeover causes the page of the displayed image 3 to be turned forward.

This time point 7T is, for example, a point in time when the second information terminal 2 transmits the information 2t via the wireless communication 2c (see FIG. 11).

It is to be noted that such transmission of the information 2t is performed, for example, when the second user 2u performs operation 2H (see FIGS. 9 to 11) on the second information terminal 2.

In addition, the structure may be such that a graphic 2G (see FIG. 11) that is a graphic user interface (GUI) such as a button is displayed on the second information terminal 2.

The above-mentioned operation 2H is, for example, operation such as touch operation etc., on this graphic 2G.

The first user 1u of the first information terminal 1 is, for example, a pupil (e.g., student) who is present in a classroom 1R (see FIG. 8) in a school, a cram school, and so on.

The second user 2u of the second information terminal 2 is, for example, a teacher (e.g., an educator and a lecturer) who is present in the classroom 1R.

As described above, the page is turned forward in each of the first information terminals 1 as a result of the relatively easy operation 2H being performed on the second information terminal 2.

The inventors of the present invention found the following points.

A case is conceivable where the number of students, i.e., the first users 1u, is relatively large around 30 to 40, for example.

This means that there are probably various users among the first users 1u.

The first users 1u include the following third user 1mu and fourth user 1nu (see FIGS. 8, 11, and 12).

The third user 1mu is the first user 1u who is appropriate to turning a page forward in the first information terminal 1 when the information 2t is transmitted.

The fourth user 1nu is the first user 1u who is not appropriate to turning a page forward in the first information terminal 1 when the information 2t is transmitted.

In addition, the third user 1mu is a user who, when the information 2t is transmitted, has already completed learning based on the image 3n1 on page n+1 displayed during the period 7Ta, for example.

On the other hand, the fourth user 1nu is a user who, when the information 2t is transmitted, has not yet completed learning based on the image 3n1 on page n+1 displayed during the period 7Ta, for example.

It is to be noted that, when the information 2t is transmitted, a state 1nuQ of such fourth user 1nu is assumed to be, for example, a state with a feeling “I am still learning” as shown in FIG. 12.

The first information terminals 1 include the following third information terminal 1m and fourth information terminal 1n (FIGS. 8 and 11, etc.),

A user of the third information terminal 1m is the above-described third user 1mu. This third information terminal 1m is the first information terminal 1. who is appropriate to turning a page forward when the information 2t is transmitted.

A user of the fourth information terminal 1n is the above-described fourth user 1nu. This fourth information terminal 1n is the first information terminal 1 who is appropriate to turning a page forward when the information 2t is transmitted.

Thus, the first information terminal 1 further includes the second display control unit 1F2 and the user information obtainment unit 1F3 in addition to the above-described first display control unit 1F1 (see FIG. 10).

By the second display control unit 1F2, the image 3n1 on page n+1 that is the same image as the image 3n1 on page n+1 displayed during the period 7Ta before the time point 7T is displayed during the period 7Tb after the above-mentioned time point 7T (see FIGS. 11 and 12).

By doing so, even after the time point 7T, the second display control unit 1F2 maintains, as the image 3 displayed on the first information terminal 1, the image 3n1 on page n+1 that is the same image as the image 3n1 on page n+1 displayed before the time point 7T.

When the page is maintained as such, the page of the image 3 displayed on the first information terminal 1 is not turned forward.

The user information obtainment unit 1F3 obtains the information (see FIG. 10).

The information 1Hi is information indicating whether the first information terminal 1 is either the above-described third information terminal 1m or the above-described fourth information terminal.

By the user information obtainment unit 1F3, a graphic 1G (see FIGS. 11 and 12 etc.) that is GUI or the like is displayed when the information 2t is transmitted (the time point 7T).

In addition, it may be that, for example, the user information obtainment unit 1F3 detects transmission of the information 2t and causes this graphic 1G to be displayed when the information 2t is transmitted.

It is to be noted that, by receiving the information 2t, the user information obtainment unit 1F3 can detect transmission of the information 2t.

Such detection of the information 2t is indicated by a two-dot chain line on the left among two two-dot chain lines between the user information obtainment unit 1F3 and the second information terminal 2 as shown in FIG. 10.

As specific examples of the in operation 1Hi, various information is conceivable.

As an example, this information 1Hi may be as follows.

The information 1Hi is operation 1H (see FIG. 11) such as touch operation on the graphic 1G by the first user 1u of the first information terminal 1, for example. This means that the information 1Hi may be information or the like inputted on the first information terminal 1 by the first user 1u.

At least part of this graphic 1G may be a graphic 1Ga (see FIG. 11) that is GUI such as a button.

This graphic 1Ga shows that the first information terminal 1 is the third information terminal 1m that is appropriate to turning a page forward. On this graphic 1Ga, operation 1H1 (FIG. 11) is performed as the above-described operation 1H.

As shown in FIG. 11, such a graphic 1Ga may be a graphic with characters “Yes” as an example.

Furthermore, at least part of this graphic 1G may be a graphic 1Gb that is GUI such as a button.

This graphic 1Gb shows that the first information terminal 1 is the fourth information terminal 1n that is not appropriate to turning a page forward. On this graphic 1Ga, operation 1H2 is performed as the above-described operation 1H.

As shown in FIG. 11, such a graphic 1Gb may be a graphic with characters “No” as an example.

It may be that only one of the above-described two operations 1H1 and 1H2 is performed.

When the operation 1H1 has been performed, the obtained information 1Hi indicates that this first information terminal 1 is the third information terminal 1m that is appropriate to turning a page forward. When the operation 1H2 has been performed, the obtained information indicates that this first information terminal 1 is the fourth information terminal 1n that is not appropriate to turning a page forward.

When the obtained information 1Hi indicates that this first information terminal 1 is the third information terminal 1m that is appropriate to turning a page forward, the user information obtainment unit 1F3 causes the first display control unit 1F1 to perform a changeover to the image 3n2 on page n+2.

When the obtained information 1Hi indicates that this first information terminal 1 is the fourth information terminal 1n that is not appropriate to turning a page forward, the user information obtainment unit 1F3 causes the second display control unit 1F2 to maintain the displayed page of the image 3.

FIG. 12 is a view for explaining operation of the system 1s.

FIG. 13 is a flowchart showing a flow of the operation of the system 1s.

As shown in FIG. 13, in Step Sa1, the second information terminal 2 transmits the information 2t when the operation 2H on the graphic 2G is performed by the second user 2u.

Each processing in Steps Sb1 to Sb5 is processing performed by the first information terminal 1 of the first user 1u.

In Step Sb2, the user information obtainment unit 1F3 of the first information terminal 1 obtains the information 1Hi (see FIG. 10) when the information 2t is transmitted in the above Step Sa1.

It is to be noted that, as described above, the first information terminal 1 may detect transmission of the information 2t. For example, receiving the transmitted information 2t by a receiving unit that is part of the user information obtainment unit 1F3 may cause the transmission of the information 2t to be detected (Sb1). When the information 2t is received, the information 1Hi is obtained (Sb2).

Here, the information 2 may be received by a receiving device located outside of the first information terminal 1, for example. In this case, the first information terminal 1 detects transmission of the information 2t by detecting reception thereof in this receiving device.

As described above, the graphic 1G (see FIG. 12) is displayed, for example, to obtain such information 1Hi.

When the information 1Hi obtained in the above Step Sb2 indicates that the first information terminal 1 is the third information terminal 1mu that is appropriate to turning a page forward (YES in Sb3), the user information obtainment unit 1F3 causes the first display control unit 1F1 to perform the following processing in Step Sb4.

Specifically, the first display control unit 1F1 changes the image 3 displayed on the first information terminal 1 from the image 3n1 on page n+1 to the image 3n2 on page n+2.

On the other hand, when the information 1Hi obtained in the above Step Sb2 indicates that the first information terminal 1 is the fourth information terminal 1n that is not appropriate to turning a page forward (NO in Sb3), the user information obtainment unit 1F3 causes the second display control unit 1F2 to perform the following processing in Step Sb5.

Specifically, the second display control unit 1F2 maintains an image 1n1 on page n+1 as the image 3 displayed on the first information terminal 1.

More specifically, in Step Sb3, the user information obtainment unit 1F3 determines whether the first information terminal 1 is either the third information terminal 1m or the fourth information terminal 1n.

For this determination, the information 1Hi obtained in the above Step Sb2 can be used. Specifically, the user information obtainment unit 1F3 may determine based on the obtained information 1Hi whether the first information terminal 1 is either the third information terminal 1m or the fourth information terminal 1n.

When it is determined that the first information terminal 1 is the third information terminal 1m (YES in Sb3), the page is turned forward (Sb4), and when it is determined that the first information terminal 1 is the fourth information terminal 1n (NO in Sb3), the page is not turned forward so that the original page continues to be displayed (Sb5).

FIG. 14 is a block diagram showing a structure of each of the first information terminal 1 and the second information terminal 2.

With the structure shown in FIG. 14, for example, the first information terminal 1 is capable of performing the above-described operation.

It is to be noted that an electronic textbook and teaching material control unit 11c shown in FIG. 14 may include a first portion, a second portion, and a third portion.

For example, the entirety (or part) of the first display control unit 1F1 shown in FIG. 10 is the first portion, the entirety (or part) of the second display control unit 1F2 shown in FIG. 10 is the second portion, and the entirety (or part) of the user information obtainment unit 1F3 shown in FIG. 10 is the third portion.

In addition, the user information obtainment unit 1F3 shown in FIG. 10 may include the entirety (or part) of an action button control unit 11f (see the graphic 1G etc., in FIG. 11),

With this system 1s, transmitting the above-described information 2t by the second information terminal 2 in the classroom 1R, for example, triggers the following operation.

The first information terminal 1 performs appropriate operation as either the above-described third information terminal 1m or the above-described fourth information terminal.

Specifically, when it is determined that the first information terminal 1 is the third information terminal 1m, the displayed image 3 is changed to the image 3n2 on page n+2 that is an image on the next page when the information 2t is transmitted. When it is determined that the first information terminal 1 is the fourth information terminal 1n, the displayed image 3 continues to be the image 3n1 on page n+1 when the information 2t is transmitted.

With this, the displayed image 3 can be set to an appropriate image regardless of whether the first information terminal 1 is the third information terminal 1m or the fourth information terminal 1n.

It is to be noted that the image 3 (e.g., the image 3n1 on page n+1 and the image 3n2 on page n+2) shown in FIG. 9 may be stored in the first information terminal 1. In this case, an obtainment unit (not shown) included in the first information terminal 1 obtains the image 3, with the result that the obtained image 3 is displayed on the first information terminal 1. Alternatively, this obtainment unit obtains the image 3 from an external device of the first information terminal 1, such as the second information terminal 2 and the storage unit 5 (see FIG. 8).

It is to be noted that details of the system 1s may have various aspects.

The aspects of the details may be known techniques, for Example.

This allows the system 1s to have a relatively simple structure.

Furthermore, the aspects of the details may be aspects with further improvements.

Furthermore, the aspects of the details may be aspects described below.

### Playback of Stored Information

FIG. 15 shows a screen 1L of the first information terminal 1 operating as the fourth information terminal 1n.

FIG. 16 is a vie or explaining operation of the first information terminal 1.

The first row in a table of FIG. 16 indicates operation of the third information terminal 1m on which the page is turned forward at the time point 7T when the information 2t is transmitted.

The second row in the table of FIG. 16 indicates operation of the fourth information terminal 1n on which the page is not turned forward at the time point 7T when the information 2t is transmitted.

In the first and second rows of FIG. 16, operation indicated further on the right is operation which occurs later in time.

By the second display control unit 1F2 of the fourth information terminal 1n, the image 3n1 on page n+1 that is the same image as the image 3n1 on page n+1 displayed in a period before the time point 7T1 is displayed after the time point 7T (the period from the time point 7T to the time point 7T1 in the second row in the table of FIG. 16), for example.

Furthermore, the second display control unit 1F2 causes an image 3P (see FIGS. 15 and 16) on page P (P=n+2, n+3, . . . , n+X) after page n+1 to be displayed after the time point 7T1.

For example, during the period from the time point 7T1 to the time point 7T2, the image 3n2 on page n+2 that is an image on the page next to the image 3n1 on page n+1 displayed during the period before the time point 7T is displayed as the image 3P on page P.

A point in time when the image 3P on page P (e.g., the image 3n2 on page n+2) starts to be displayed on the fourth information terminal 1n (the time point 7T1) is later than the a point in time when the image 3P (e.g., the image 3n2) starts to be displayed on the third information terminal 1m (the time point 7T).

When the image 3P (e.g., the image 3n2) is displayed on the third information terminal 1m during the period from the time point 7T to the time point 8T2, the information 6 (see FIG. 1) is displayed together with the image 3P.

This information 6 may be audio such as speaking voice of the second user 2u or may also be video data such as a figure of the second user 2u, for example. Alternatively, the information 6 may be an image etc., such as a character, a graphic, and a picture drawn on an electronic blackboard by the second user 2u or may also be an image, audio, etc., of a supplementary material used in combination with the electronic textbook.

The system 1s includes the information obtainment unit 6g (see FIGS. 8 and 10) that obtains this information 6.

This information obtainment unit 6g is a video camera, for example.

In this case, the information 6 is video of the second user 2u recorded by this video camera, for example.

This video camera etc., is mounted on the ceiling or the like of the classroom 1R.

The information obtainment unit 6g may be a microphone, for example.

In this case, the information 6 is speaking voice of the second user 2u recorded using this microphone, for example. This microphone may be provided in the second information terminal 2.

For the sake of convenience for illustration, FIG. 8 shows the case where the information obtainment unit 6g is provided outside the second information terminal 2.

Furthermore, the system 1s includes the storage unit 5 (see FIGS. 8, 10, and 14) that stores the information 6.

The information obtainment unit 6g may be provided in this storage unit 5 and may obtain video from the video camera mounted in the classroom 1R.

As described above, the second display control unit 1F2 plays back the information 6 (the information 6n2 in FIG. 16) when the image 3P on page P (e.g., the image 3n2 on page n+2 described above) is displayed.

As shown in FIG. 15, the information 6 is displayed together with the image 3P on the fourth information terminal 1n. With this, the fourth user 1nu can view the image 3P and also view and listen to the information 6. This is represented by the image 3n2 and the information 6n2 shown in the part from the time point 7T1 to the time point 7T2 in the second row in the table of FIG. 16, for example.

With this, in the fourth information terminal 1n, the page is not turned forward at the time point 7T, and the image 3P starts to be displayed and the information 6 starts to be played back at the time point 7T1 after the time point 7T at which the image 3P starts to be displayed on the third information terminal 1m.

The third user 1mu of the fourth information terminal 1n can view the image 3P and also view and listen to the information 6.

It is to be noted that, as shown in FIG. 15, in a first region 1Ra that is the left half region of the screen 1L on the fourth information terminal 1n, the image 3P on page P is displayed, and in a second region 1Rb that is the right half region of the screen 1L on the fourth information terminal 1n, the information 6 is played back, for example (see the part from the time point 7T1 to the time point 7Ts in the second row in the table of FIG. 16).

In addition, it may be that, as shown in FIG. 16, in the period before the time point 7T1, the image 3n1 on page n+1 is displayed, and a graphic 2B1 (see FIGS. 11 and 12) that is GUI or the like, such as a button, is displayed.

The time point 7T1 may be a time point when operation 1J (see FIGS. 11 and 12) such as touch operation is performed on this graphic 2B1, for example.

This means that when this operation 1J is performed, the image 3n2 on page n+2 starts to be displayed, and the information 6 (the information 6n2) starts to be played back.

This graphic 2B1 is a graphic for starting playback of the information 6n2 corresponding to the image 3n2 on page n+2.

Likewise, a graphic 2Bn2 (see FIG. 5) for starting playback of information 6n3 corresponding to an image 3n3 on page n+3 is displayed. Thus, graphics 2Bn1, 2Bn2, . . . , and 2BnX for individually starting playback of information 6n2, 6n3, . . . , and 6nX corresponding to respective pages are displayed.

In addition, for example, as a result of the operation being performed on the graphic 1Gb, not only the graphic 2Bn1 which has been displayed since before the operation was performed, but also the graphic 2Bn2 corresponding to a page next to the page corresponding to the graphic 2Bn1, is displayed. Thus, each time the operation on the graphic 1Gb is performed, the number of graphics 2Bn1, 2Bn2, . . . , 2BnX for starting playback increases one by one.

In addition, a button 6B1 for fast-forwarding playback of the information 6, a button 6B2 for skipping playback of the information 6, and so on, may be displayed. Thus, when determining that the playback of the information 6 is unnecessary, a user can operate these buttons 6B1 and 6B2.

FIG. 17 is a flowchart showing a flow of the operation of the system 1s.

In Step Sd2, when the operation on the graphic 1Gb is performed, the second display control unit 1F2 causes the graphics 2Bn1, 2Bn2, . . . , 2BnX for starting playback of the information 6 to be displayed.

In Step Sd3, the operation 1J such as touch operation on these graphics 2Bn1, 2Bn2, . . . , 2BnX is performed.

In Step Sd4A, the second display control unit 1F2 starts playback of the information 6 when the operation 1J has been performed in the above Step Sd3.

In addition, when it is determined based on the information 1Hi that the first information terminal 1 is the fourth information terminal 1n, the information 1i is transmitted from the first information terminal 1 to the second information terminal 2 (Sd1).

When the first information terminal 1 transmits the information 1i, the information 6 is stored into the storage unit 5, and when the first information terminal 1 does not transmit the information 1i, the information 6 is not stored into the storage unit 5.

A control unit (not shown) which provides such control may be provided in the second terminal 2 or may be provided in the storage unit 5, for example. Alternatively, this control unit may be provided outside the present system 1s.

Processing in Step Sc2A is performed by the storage unit 5.

The storage unit 5 may include a first portion 51 and a second portion 52 (see FIG. 14). For example, the information 6 is stored into the second portion 52. This second portion 52 may be provided in the second information terminal 2, for example.

Processing in Step Sc2A (FIG. 9) may be performed by the second portion 52 of the storage unit 5 in the second information terminal 2.

In Step Sc2, the information 6 obtained by the information obtainment unit 6g is stored into the second portion 52 of the storage unit 5.

In Step Sc3, the information 6 is transmitted to the fourth information terminal 1n which has transmitted the information 1i in the above Step Sd1, and in the fourth information terminal 1n, the information 6 is played back.

It is to be noted that, for example, part of the period in which the processing in Step Sc2 is performed (the period from the time point 7T to the time point 8T2 in FIG. 16) may overlap with part of the period in which the processing in Step Sc3 is performed (the period from the time point 7T1 to the time point 7T2 in FIG. 16). During this overlap period, processes in these Steps Sc2 and Sc3 may be performed in two different threads, for example; they may be performed in parallel.

### Omission In Recorded Information

FIG. 18 is a block diagram showing a structure related to the omission processing unit 1Fa.

FIG. 19 is a block diagram showing a structure related to a filter 5xF.

FIG. 20 is a view for explaining operation of the omission processing unit 1Fa.

As shown in FIGS. 18 and 20, the system 1s includes the omission processing unit 1Fa.

The omission processing unit 1Fa converts the recorded information 6 from the information 6x to the information 6y.

As shown in FIG. 20, the time 6yT required to play back the information 6y resulting from the conversion is shorter than the time 6xT required to play back the information 6x having not yet undergone the conversion.

The information 6x having not yet undergone the conversion includes first information that is not preferable to be deleted and second information that is deletable.

The information 6y resulting from the conversion includes the above first information only and does not include the above second information. Consequently, the time 6yT required to play back the information 6y is relatively short.

In other words, performing the above-described conversion causes the above second information to be deleted, for example. Thus, the omission processing unit 1Fa performs omission processing that is processing for generating the information 6y which is played back in the relatively short time 6yT.

Upon playing back the information 6 (Sd4A in FIG. 9), the second display control unit 1F2 may play back, as the information 6, the information 6y resulting from the conversion instead of the information 6x having not yet undergone the conversion.

For the sake of convenience for explanation, such omission processing is referred to as “filtering” where appropriate. Part or all of the omission processing unit 1Fa may be a filter 5xF that performs such “filtering” (see FIG. 18).

It is to be noted that the same number of omission processing units 1Fa as the first information terminals 1 may be provided.

The second display control unit 1F2 of each of the first information terminals may include the omission processing unit 1Fa.

It is to be noted that the information 6y resulting from the conversion may be played back in a fast-forward mode.

Furthermore, when playing back the information 6y resulting from the conversion, it may be possible to display, instead of animation displayed when playing back the information 6x having not yet undergone the conversion, a still image or the like which corresponds to such animation.

Moreover, when playing back the information 6y resulting from the conversion, it may be possible to display, instead of a text displayed when playing back the information 6x having not yet undergone the conversion, an abstract of such a text.

In addition, when playing back the information 6y resulting from the conversion, it may be possible to skip part of the information 6x having not yet undergone the conversion which is played back when playing back the information 6x.

Here, the part which is skipped may be information on drill problems, for example.

Furthermore, the part which is skipped may be content of a past lesson given before the present lesson, for example.

Moreover, the part which is skipped may be content already learned by the first user 1u through learning in a lesson in a cram school and preparation at home before the present lesson, for example.

### Processing Corresponding To End Point In Time Of Lesson

FIG. 21 is a flowchart showing a flow of the processing of the present system 1s.

The processing shown in FIG. 21 is processing in Step Sd4A in FIG. 17 which is performed by the first information terminal 1 operating as the fourth information terminal 1n.

In Step Se1, the second display control unit 1F2 of the first information terminal 1 specifies an end point in time of a lesson given by the second user 2u.

In Step Se1, the second display control unit 1F2 determines whether or not a process of displaying the image 3 on all the pages will be completed in the fourth information terminal 1n by the specified point in time.

When the second display control unit 1F2 determines that the process of displaying will not be completed (NO in Se1), processing in Step Se6 is performed.

In Step Se6, the second display control unit 1F2 causes the image 3 on the same page as the page of the image 3 displayed on the third information terminal 1m to be displayed (see the second row in the table of FIG. 16).

In other words, it may be that, when the second display control unit 1F2 determines that the process of displaying will not be completed, the same page as the page displayed on the third information terminal 1m is displayed on the fourth information terminal 1n after such determination.

It is to be noted that a case where such processing is performed is, for example, a case where the time 6yT required to play back the information 6y resulting from the conversion is 0 (zero).

Thus, for the sake of convenience for explanation, this processing is referred to as “forcible omission processing” where appropriate as shown in Step Se6.

On the other hand, when the second display control unit 1F2 determines that the process of displaying the image 3 on all the pages will be completed by the specified end point in time of the lesson, the information 6 (e.g., the information 6n2) stored in the storage unit 5 and the image 3 (e.g., the image 3n2) corresponding to a page of the information 6 are displayed in Step Se4.

More specifically, processes in Steps Se2 and Se3 are Performed.

In Step Se2, the second display control unit 1F2 determines whether or not the omission processing is possible.

When the second display control unit 1F2 has determined that the omission processing is possible (YES in Se2), the omission processing is performed (Se3). In this case, the second display control unit 1F2 plays back, as the information 6, the information 6x on which the omission processing has been performed.

### Take-Out of Information Terminal

FIG. 22 is a flowchart showing a flow of processing in the fourth information terminal 1n.

The fourth information terminal 1n may be taken to a place outside the classroom 1R, e.g., a home 1H of the fourth user 1nu when the above-described process in Step Se6 is performed, for example.

The fourth information terminal 1n is taken out, for example, after a lesson ends.

FIG. 8 schematically shows such take-out of the fourth information terminal 1n as movement 1Hm of the fourth information terminal 1n.

In the second display control unit 1F2, the information 6 stored in the storage unit 5 is played back at the home 1H of the fourth user 1nu after a lesson ends (Sf4).

As shown in FIG. 22, processes in Steps Sf1 to Sf3 are performed, for example.

In Step Sf1, the second display control unit 1F2 of the first information terminal 1 transmits a request to the storage unit 5.

There is a case where the first information terminal 1 becomes the fourth information terminal 1n (NO in Sb3 in FIG. 13) and the above-described process in Step Se6 is performed.

In Step Sf2, the second display control unit 1F2 obtains, from the storage unit 5 which received the request, a notification indicating whether the number of lessons in which the process in Step Se6 has been performed is either at least one or 0.

In Step Sf3, the second display control unit 1F2 determines based on this notification whether the number of lessons is either at least one (YES in Sf2) or 0 (NO in Sf2).

In Step Sf3, the second display control unit 1F2 obtains, from the storage unit 5, data specifying each at least one lesson (a list of unattended lessons shown in FIG. 22).

In Step Sf4, video 6 of a lesson included in at least one lesson identified by data obtained as above is played back.

In Step Sf4, the video 6 is displayed on a user interface (UI) designated on the first information terminal 1 by a user.

It is to be noted that a lesson recorded in the video 6 which is played back may be a lesson designated on this UI.

It is to be noted that the storage unit 5 may be a cloud server etc., connected to a network 5N (see FIG. 8) such as the Internet, for example.

For example, when the fourth information terminal 1n is taken to the home 1H, the second display control unit 1F2 may play back the information 6 obtained from the storage unit 5 via the network 5N.

### Others

FIGS. 23 and 24 each show a structure of lessons which are given by the second user 2u.

For example, the structures of lessons as shown in information 2Vb in FIG. 23 and information 2Va in FIG. 24 are planned by the second user 2u.

Actions of the second user 2u, such as a speech and writing on an electronic blackboard, related to content of an electronic textbook are based on such structures of lessons, for example.

FIG. 25 shows information stored e storage unit 5.

As shown in FIG. 25, in the storage unit 5, information such as teaching material attribute information is stored, for example.

FIG. 26 shows the second information terminal 2.

The second information terminal 2 includes the instruction transmitting unit 2F1 which transmits the information 2t (the first information) via the wireless communication 2c, as shown in FIG. 10.

The second information terminal 2 further includes the display control unit 2F2 which obtains information 1i from each of the first information terminals 1.

The obtained information 1i indicates whether or not, in the first information terminal 1 which transmitted the information 1i, a changeover (see Sb4) to the image 3n2 on a next page (page n+2) has been performed when the information 2t (such as FIG. 2) is transmitted (see the time point 7T).

The display control unit 2F2 displays the graphic object 2j (the graphic objects 2jm and 2jn) shown in FIG. 26.

The graphic object 2j includes the graphic objects 2jm and 2jn indicating whether or not the pages have been turned forward, which is indicated in the obtained information 1i.

Specifically, the graphic object 2j includes the graphic objects 2jm and 2jn which correspond to the respective first information terminals 1.

For example, when the page has been turned forward in the first information terminal 1, the graphic object 2jm includes, as shown in FIG. 26, a number indicating a page number of the page reached by the forward-paging action. With this number, the fact that page has been turned forward is indicated.

On the other hand, when the page has not been turned forward in the first information terminal 1, the graphic object 2jn includes a number indicating a page number (e.g., the page number of page n+1) of the image 3 which is being displayed on the second information terminal 2. With this number, the fact that page has not been turned forward is indicated. In FIG. 26, this number is denoted by “n” for the sake of convenience for explanation.

It is to be noted that further details of the system 1s may have various aspects.

For example, the storage unit 5 may include a storage unit 5x which stores information 5xa (see FIG. 8) related to all or part of the structures of lessons shown in FIGS. 23 and 24.

It is to be noted that the wireless communication 2c between the first information terminal 1 and the second information terminal 2 may be ad hoc communication, for example.

It is to be noted that the present system 1s may be one lesson support system (lesson support device) and may also be one communication system or the like.

In addition, also in the second information terminal 2, the image (e.g., the image 3n2) on the page next to the page of the image (e.g., the image 3n1) which had been displayed on the second information terminal 2 before the information 2t was transmitted may be displayed after the information 2t was transmitted (after the time point 7T).

In other words, also in the second information terminal 2, the page may be turned forward when the information 2t is transmitted.

Each of the structural elements in each of the above-described embodiments may be configured in the form of an exclusive hardware product or may be realized by executing a software program suitable for the structural element. Each of the structural elements may be realized by means of a program executing unit, such as a CPU or a processor, reading and executing the software program recorded on a recording medium such as a hard disk or a semiconductor memory. Here, the software program for realizing the teacher information terminal, the student information terminal, and so on according to each of the embodiments is a program described below.

Specifically, this program causes a computer to execute: causing a display unit to display same data as data of the content displayed on each of the student information terminals; and transmitting paging-forward instructions concurrently to the student information terminals each time a page of the content displayed on the display unit is turned forward, the paging-forward instructions each being for instructing turning-forward of a page of the content displayed on a corresponding one of the student information terminals, wherein, when the paging-forward instructions are transmitted concurrently to the student information terminals in the transmitting, an inquiry is made to the user of each of the student information terminals about whether or not the user accepts a corresponding one of the paging-forward instructions, and the page of the content displayed on the student information terminal is turned forward when a result of the inquiry is that the user accepts the paging-forward instruction, and the page of the content displayed on the student information terminal is not turned forward when the result of the inquiry is that the user does not accept the paging-forward instruction.

Alternatively, this program causes a computer to execute: causing a display unit to display same data as data of a page of the content displayed on the teacher information terminal; receiving a paging-forward instruction from the teacher information terminal each time the page of the content displayed on the teacher information terminal is turned forward, the paging-forward instruction being for instructing turning-forward of a page of the content displayed on the display unit; making an inquiry to a user of the student information terminal about whether or not the user accepts the paging-forward instruction when receiving the paging-forward instruction; and turning forward the page of the content displayed on the display unit when a result of the inquiry is that the user accepts the paging-forward instruction, and avoiding turning forward the page of the content displayed on the display unit when the result of the inquiry is that the user does not accept the paging-forward instruction.

It is to be noted that functional blocks in the block diagrams (FIGS. 3 and 5, for example) are typically implemented as a large-scale integration (LSI) that is an integrated circuit. These functional blocks may be each formed into a single chip, and it is also possible to integrate part or all of these functional blocks in a single chip. Alternatively, among the functional blocks, functional blocks other than the storage unit which stores data may be formed into a single chip. Although the LSI is mentioned here, it may also be called IC, system LSI, super LSI, or ultra LSI depending on the degree of integration. Moreover, ways to achieve integration are not limited to the LSI, and a special circuit or a general purpose processor can also achieve the integration. Field Programmable Gate Array (FPGA) that can be programmed after manufacturing LSIs or a reconfigurable processor that allows re-configuration of the connection or configuration of an LSI can be used for the same purpose. In the future, with advancement in semiconductor technology, a brand-new technology may replace LSI. The functional blocks can be integrated using such a technology. The possibility is that the present invention is applied to biotechnology.

Although the educational system, the teacher information terminal, the student information terminal, the integrated circuit, and the content display method according to one or more aspects have been described above based on the embodiments, the present invention is not limited to these embodiments. One or more aspects of the present invention may include embodiments obtained by making various modifications which those skilled in the art could make in the above embodiments and by arbitrarily combining the structural elements in different embodiments unless such embodiments depart from the principles and spirit of the present invention.

### INDUSTRIAL APPLICABILITY

The present invention relates to an educational system and a content display method for giving lessons based on content whose data is the same between student information terminals and a teacher information terminal which wirelessly communicates with each of the student information terminals, Furthermore, the present invention is applicable as the teacher information terminal, the student information terminals, and an integrated circuit which are used in the above educational system.

### REFERENCE SIGNS LIST

1s System
1R Classroom
1H Home
1 First information terminal
1m Third information terminal
1n Fourth information terminal
2 Second information terminal
1u First user
1mu Third user
1nu Fourth user
2u Second user
2c Wireless communication
6 Information
5 Storage unit
6g Information obtainment unit
3, 3n1 to 3nX Image
6, 6n2 to 6nX Information
1F1 First display control unit
1F2 Second display control unit
1F3 User information obtainment unit
2F1 Instruction transmitting unit
2F2 Display control unit
7T, 7T1 to 7T3, 7Ts, 8T2 to 8T3 Time point
1Fs Omission processing unit
6x, 6y Information
6xT, 6yT Length of time
10 Educational system
20, 30 User
100 Teacher information terminal
101, 201 Storage unit
102, 202 Display unit
102a, 102b, 202a, 202b Region
103, 203 Input unit
103a, 121, 203a, 203b, 203c, 221 Icon
104, 204 Control unit
111 Generation unit
112, 212 Communication unit
113, 214 Display control unit
200 Student information terminal
211 Inquiry processing unit
213 Inquiry unit
215 Paging-forward processing unit

1. An educational system for giving a lesson based on content whose data is same between student information terminals and a teacher information terminal which wirelessly communicates with each of the student information terminals,
the teacher information terminal including:
a first display control unit configured to cause the content to be displayed on a first display unit; and
a transmitting unit configured to transmit paging-forward instructions concurrently to the student information terminals each time a page of the content displayed on the first display unit is turned forward, the paging-forward instructions each being for instructing turning-forward of the page of the content, and
the student information terminals each including:
a second display control unit configured to cause same data as data of the page of the content displayed on the first display unit to be displayed on a second display unit;
a receiving unit configured to receive one of the paging-forward instructions from the teacher information terminal;
an inquiry unit configured to make an inquiry to a user of the student information terminal about whether or not the user accepts the paging-forward instruction when the receiving unit receives the paging-forward instruction; and
a paging-forward processing unit configured to turn forward a page of the content displayed on the second display unit of the student information terminal when a result of the inquiry is that the user accepts the paging-forward instruction, and avoid turning forward the page of the content displayed on the second display unit of the student information terminal when the result of the inquiry is that the user does not accept the paging-forward instruction.

2. The educational system according to claim 1,
wherein each of the student information terminals further includes an inquiry processing unit configured to transmit the result of the inquiry to the teacher information terminal when the result of the inquiry is that the user does not accept the paging-forward instruction, and
the first display control unit is configured to cause the first display unit to display, together with the content, the result of the inquiry in association with a particular one of the student information terminals when the result of the inquiry from the particular student information terminal is received by the teacher information terminal.

3. The educational system according to claim 1,
wherein the second display control unit is configured to cause the second display unit to display, together with the content, an icon indicating that the user does not accept the paging-forward instruction when the result of the inquiry is that the user does not accept the paging-forward instruction.

4. The educational system according to claim 1,
wherein each of the student information terminals further includes an input unit which is operated by the user, and
when the page of the content is not turned forward against the paging-forward instruction, the paging-forward processing unit is configured to turn forward the page of the content displayed on the second display unit upon operation of the input unit by the user.

5. The educational system according to claim 4,
wherein, when the receiving unit receives the paging-forward instruction, the inquiry unit is configured to:
avoid making the inquiry to the user about whether or not the user accepts the paging-forward instruction when the page of the content displayed on the second display unit is behind the page of the content displayed on the first display unit; and
make the inquiry to the user about whether or not the user accepts the paging-forward instruction when the page of the content displayed on the second display unit matches the page of the content displayed on the first display unit.

6. A teacher information terminal which wirelessly communicates with each of student information terminals, the teacher information terminal comprising:
a display control unit configured to cause a display unit to display same data as data of content displayed on each of the student information terminals; and
a transmitting unit configured to transmit paging-forward instructions concurrently to the student information terminals each time a page of the content displayed on the display unit is turned forward, the paging-forward instructions each being for instructing turning-forward of a page of the content displayed on a corresponding one of the student information terminals,
wherein, when the transmitting unit transmits the paging-forward instructions concurrently to the student information terminals, an inquiry is made to the user of each of the student information terminals about whether or not the user accepts a corresponding one of the paging-forward instructions, and the page of the content displayed on the student information terminal is turned forward when a result of the inquiry is that the user accepts the paging-forward instruction, and the page of the content displayed on the student information terminal is not turned forward when the result of the inquiry is that the user does not accept the paging-forward instruction.

7. A student information terminal which wirelessly communicates with a teacher information terminal, the student information terminal comprising:
a display control unit configured to cause a display unit to display same data as data of a page of the content displayed on the teacher information terminal;
a receiving unit configured to receive a paging-forward instruction from the teacher information terminal each time the page of the content displayed on the teacher information terminal is turned forward, the paging-forward instruction being for instructing turning-forward of a page of the content displayed on the display unit;
an inquiry unit configured to make an inquiry to a user of the student information terminal about whether or not the user accepts the paging-forward instruction when the receiving unit receives the paging-forward instruction; and
a paging-forward processing unit configured to turn forward the page of the content displayed on the display unit when a result of the inquiry is that the user accepts the paging-forward instruction, and avoid turning forward the page of the content displayed on the display unit when the result of the inquiry is that the user does not accept the paging-forward instruction.

8. An integrated circuit included in a teacher information terminal which wirelessly communicates with each of student information terminals, the integrated circuit comprising:
a display control unit configured to cause a display unit to display same data as data of content displayed on each of the student information terminals; and
a transmitting unit configured to transmit paging-forward instructions concurrently to the student information terminals each time a page of the content displayed on the display unit is turned forward, the paging-forward instructions each being for instructing turning-forward of a page of the content displayed on a corresponding one of the student information terminals,
wherein, when the transmitting unit transmits the paging-forward instructions concurrently to the student information terminals, an inquiry is made to the user of each of the student information terminals about whether or not the user accepts a corresponding one of the paging-forward instructions, and the page of the content displayed on the student information terminal is turned forward when a result of the inquiry is that the user accepts the paging-forward instruction, and the page of the content displayed on the student information terminal is not turned forward when the result of the inquiry is that the user does not accept the paging-forward instruction.

9. An integrated circuit included in a student information terminal which wirelessly communicates with a teacher information terminal, the integrated circuit comprising:
a display control unit configured to cause a display unit to display same data as data of a page of the content displayed on the teacher information terminal;
a receiving unit configured to receive a paging-forward instruction from the teacher information terminal each time the page of the content displayed on the teacher information terminal is turned forward, the paging-forward instruction being for instructing turning-forward of a page of the content displayed on the display unit;
an inquiry unit configured to make an inquiry to a user of the student information terminal about whether or not the user accepts the paging-forward instruction when the receiving unit receives the paging-forward instruction; and
a paging-forward processing unit configured to turn forward the page of the content displayed on the display unit when a result of the inquiry is that the user accepts the paging-forward instruction, and avoid turning forward the page of the content displayed on the display unit when the result of the inquiry is that the user does not accept the paging-forward instruction.

10. A content display method for giving a lesson based on content whose data is same between student information terminals and a teacher information terminal which wirelessly communicates with each of the student information terminals, the content display method comprising:
causing a display unit to display same data as data of the content displayed on each of the student information terminals; and
transmitting paging-forward instructions concurrently to the student information terminals each time a page of the content displayed on the display unit is turned forward, the paging-forward instructions each being for instructing turning-forward of a page of the content displayed on a corresponding one of the student information terminals,
wherein, when the paging-forward instructions are transmitted concurrently to the student information terminals in the transmitting, an inquiry is made to the user of each of the student information terminals about whether or not the user accepts a corresponding one of the paging-forward instructions, and the page of the content displayed on the student information terminal is turned forward when a result of the inquiry is that the user accepts the paging-forward instruction, and the page of the content displayed on the student information terminal is not turned forward when the result of the inquiry is that the user does not accept the paging-forward instruction.

11. A content display method for giving a lesson based on content whose data is same between student information terminals and a teacher information terminal which wirelessly communicates with each of the student information terminals, the content display method comprising:
causing a display unit to display same data as data of a page of the content displayed on the teacher information terminal;
receiving a paging-forward instruction from the teacher information terminal each time the page of the content displayed on the teacher information terminal is turned forward, the paging-forward instruction being for instructing turning-forward of a page of the content displayed on the display unit;
making an inquiry to a user of the student information terminal about whether or not the user accepts the paging-forward instruction when receiving the paging-forward instruction; and
turning forward the page of the content displayed on the display unit when a result of the inquiry is that the user accepts the paging-forward instruction, and avoiding turning forward the page of the content displayed on the display unit when the result of the inquiry is that the user does not accept the paging-forward instruction.
